(19) United States
(12) Patent Application Publication
(10) Pub. No.: US 2026/0095961 A1
(43) Pub. Date: Apr. 2, 2026

(54) METHODS AND PROCEDURES FOR EXTENDED TRIGGER BASED TRANSMISSION

(71) Applicant: INTERDIGITAL PATENT HOLDINGS, INC., Wilmington, DE (US)

(72) Inventors: Hanqing Lou, Syosset, NY (US); Ying Wang, Easton, PA (US); Xiaofei Wang, North Caldwell, NJ (US); Mahmoud Saad, Montreal (CA); Rui Yang, Greenlawn, NY (US)

(73) Assignee: INTERDIGITAL PATENT HOLDINGS, INC., Wilmington, DE (US)

(21) Appl. No.: 18/904,763

(22) Filed: Oct. 2, 2024

(51) Int. Cl. H04W 76/11

(52) U.S. Cl. CPC H04W 76/11

(57) ABSTRACT

A STA receives a trigger frame comprising a common information field, user information fields, and a special user information field. The STA determines one of a first, second or third variant according to: a first bit pattern of common information field selection bits indicates a first variant, a second bit pattern of the common information field selection bits and a value of an identifier field of the special user information field indicates one of a second or third variant, and a third bit pattern of the common information field selection bits and a value of the identifier field of the special user information field and a value of an identifier field of the user information field associated with the STA indicates one of the first, second or third variant. The STA transmits a trigger based (TB) physical protocol data unit (PPDU) of type the determined first, second, or third variant.

### BACKGROUND

A wireless local area network (WLAN) in Infrastructure Basic Service Set (BSS) mode has an Access Point (AP) for the BSS and one or more stations (STAs) associated with the AP. The AP typically has access or interface to a Distribution System (DS) or another type of wired/wireless network that carries traffic in and out of the BSS. Traffic to STAs that originates from outside the BSS arrives through the AP and is delivered to the STAs. Traffic originating from STAs to destinations outside the BSS is sent to the AP to be delivered to the respective destinations. Traffic between STAs within the BSS may also be sent through the AP where the source STA sends traffic to the AP and the AP delivers the traffic to the destination STA. Such traffic between STAs within a BSS is peer-to-peer traffic, which may also be sent directly between the source and destination STAs with a direct link setup (DLS) using an 802.11e DLS or an 802.11z tunneled DLS (TDLS). A WLAN using Independent BSS (IBSS) mode has no AP, and the STAs using such an IBSS may communicate directly with each other. This mode of communication is referred to as an “ad-hoc” mode of communication.

Using the 802.11ac infrastructure mode of operation, the AP may transmit a beacon on a fixed channel, usually the primary channel. This channel may be 20 MHz wide and is the operating channel of the BSS. This channel is also used by the STAs to establish a connection with the AP. The fundamental channel access mechanism in an 802.11 system is Carrier Sense Multiple Access with Collision Avoidance (CSMA/CA). In this mode of operation, every STA, including the AP, will sense the occupancy or vacancy of the primary channel. If the channel is detected to be busy, the STA backs off. Hence only one STA may transmit at any given time, frequency, and space resources in each BSS.

In 802.11n, High Throughput (HT) STAs may also use a 40 MHz wide channel for communication. This is achieved by combining the primary 20 MHz channel, with an adjacent 20 MHz channel to form a 40 MHz wide contiguous channel.

In 802.11ac, Very High Throughput (VHT) STAs may support 20 MHz, 40 MHz, 80 MHz, and 160 MHz wide channels. The 40 MHz and 80 MHz channels are formed by combining contiguous 20 MHz channels as described above for 802.11n. A 160 MHz channel may be formed either by combining 8 contiguous 20 MHz channels, or by combining two non-contiguous 80 MHz channels, which may be referred to as an 80+80 configuration. For the 80+80 configuration, at the transmitter, the data, after channel encoding, may be passed through a segment parser that divides the data into two streams. Inverse fast Fourier transform (IFFT) and time domain processing are done on each stream separately. The two streams are then mapped onto the two 80 MHz channels for transmission. At the receiver, this mechanism is reversed, and the combined data from the two 80 MHz channels is sent to the medium access control (MAC) layer.

In 802.11ax, High Efficiency (HE) Wireless STAs may support 20 MHz, 40 MHz, 80 MHz, and/or 160 MHz wide channels capable of transmission over 2.4 GHZ, 5 GHZ, and 6 GHz frequency bands using both orthogonal frequency-division multiple access (OFDMA) and multi-user multiple-input multiple-output (MU-MIMO) capabilities. OFDMA subcarrier modulation in HE STAs includes formats such as BPSK, QPSK, 16-QAM, 64-QAM, 256-QAM, and 1024-QAM. The evolution of 802.11 to Extremely High Throughput (EHT, or 802.11be) STAs extends to having 320 MHz wide channels.

Sub 1 GHz modes of operation are supported by 802.11af and 802.11ah. For these specifications the channel operating bandwidths, and the number of Orthogonal frequency-division multiplexing (OFDM) subcarriers, are reduced relative to those used in 802.11n and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. A possible use case for 802.11ah is support for Meter Type Control (MTC) devices in a macro coverage area. MTC devices may have limited capabilities with limited bandwidths, but they may require a very long battery life.

WLAN systems that support multiple channels and channel widths, such as 802.11n, 802.11ac, 802.11af, 802.11ah, 802.11ax, and 802.11be, include a channel that is designated as the primary channel. The primary channel may, but not necessarily, have a bandwidth equal to the largest common operating bandwidth supported by all STAs in the BSS. The bandwidth of the primary channel is therefore limited by the STA that supports the smallest bandwidth operating mode in the BSS. In the example of 802.11ah, the primary channel may be 1 MHz wide if there are STAs (e.g. MTC type devices) that only support a 1 MHz mode even if the AP, and other STAs in the BSS, may support 2 MHz, 4 MHz, 8 MHz, 16 MHz, or other channel bandwidth operating modes. All carrier sensing and NAV settings depend on the status of the primary channel, i.e., if the primary channel is busy, for example, due to a STA supporting only a 1 MHz operating mode is transmitting to the AP, then the entire available frequency bands are considered busy even though majority of it stays idle and available.

To improve spectral efficiency, 802.11n started to introduce the multiple-input multiple-output (MIMO) technology, which multiplies capacity by transmitting up to 4 spatial streams (or data streams) over different antennas. 802.11ac further introduced downlink multi-user MIMO (MU-MIMO) transmission, where multiple users may send their spatial streams (max 4 per user, total up to 8) over different antennas simultaneously on the same frequency, i.e., on the same OFDM subcarrier and in the same OFDM symbol. 802.11ax and 802.11be use both orthogonal frequency-division multiple access (OFDMA), which is multiplexing users in the frequency domain, and UL/DL MU-MIMO, which is multiplexing users in the spatial domain.

The IEEE 802.11 Ultra High Reliability (UHR), or 802.11bn, Study Group was formed in September 2022. UHR is considered as the next major revision to IEEE 802.11 standards following 802.11be (or EHT), which is currently in the Working Group Letter Ballot Stage. UHR explores the possibility to improve reliability, support further reduced low latency traffic, further increase peak throughput, improve power saving capabilities, and improve efficiency of the IEEE 802.11 network over EHT.

### SUMMARY

Procedures are disclosed for determining a trigger based (TB) physical protocol data unit (PPDU) variant in response to receiving a trigger frame. A first STA may receive, from a second STA, a trigger frame comprising a common information field including common information field selection bits, a plurality of user information fields including respective first identifier fields, and a special user information field including a second identifier field. The first STA may determine one of a first, second or third variant based on the common information field selection bits, the second identifier field of the special user information field, and the first identifier field of the user information field associated with the first STA, wherein: a first bit pattern of the common information field selection bits indicates a first variant, a second bit pattern of the common information field selection bits and a value of the second identifier field of the special user information field indicates one of a second variant or a third variant, and a third bit pattern of the common information field selection bits and a value of the second identifier field of the special user information field and a value of the first identifier field of the user information field associated with the first STA indicates one of the first variant, the second variant or a third variant. The first STA may transmit a TB PPDU with type being based on the determined first, second, or third variant. In an example, the first variant is high efficiency (HT) associated with 802.11ax, the second variant is extremely high throughput (EHT) associated with 802.11be, and the third variant is ultra high reliability (UHR) associated with 802.11bn.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a frame format diagram illustrating an example trigger frame format;

FIG. 3 is a frame format diagram illustrating an example common information field format, which may be included in a trigger frame;

FIG. 4 is a frame format diagram illustrating an example user information field format, for which multiple may be included in a trigger frame;

FIG. 5 is a frame format diagram illustrating an example Extremely High Throughput (EHT) variant common information field format, which may be included in a trigger frame;

FIG. 6 is a frame format diagram illustrating an example special user information field format, for which multiple may be included in a trigger frame;

FIG. 7 is a frame format diagram illustrating an example EHT variant user information field format, for which multiple may be included in a trigger frame;

FIG. 8 is a system diagram illustrating an example wireless communication system 800 where a trigger frame is used to trigger one or more trigger based (TB) physical protocol data units (PPDUs);

FIGS. 9A and 9B are a flow diagram illustrating an example procedure for determining a TB PPDU variant, performed by a STA in response to receiving a trigger frame that includes a user information field addressed to the STA;

FIGS. 10A and 10B are a flow diagram illustrating another example procedure for determining a TB PPDU variant, performed by a STA in response to receiving a trigger frame that includes a user information field addressed to the STA;

FIGS. 11A and 11B are a flow diagram illustrating another example procedure for determining a TB PPDU variant, performed by a STA in response to receiving a trigger frame that includes a user information field addressed to the STA;

FIG. 12 is a frame format diagram illustrating an example trigger frame format including a UHR/UHR+ variant common info and/or special user info field added before the padding bits at the end of the trigger frame;

FIG. 13 is a frame format diagram illustrating an example trigger frame 1300 format including a Ultra High Reliability (UHR)/UHR+ variant common information field and/or special user information field;

FIG. 14 is a frame format diagram illustrating an example trigger frame format including multiple special user information fields;

FIG. 15 is a frame format diagram illustrating another example trigger frame format including multiple special user information fields;

FIG. 16 is a flow diagram illustrating an example procedure for determining a TB PPDU variant, performed by a first STA that is a UHR or UHR+ STA, in response to receiving a trigger frame that includes a user info field addressed to the first STA;

FIG. 17 is a frame format diagram illustrating an example user information field format for unequal modulation (UEQM); and

FIG. 18 is a frame format diagram illustrating an example user information field format for Enhanced Long Range (ELR).

### DETAILED DESCRIPTION

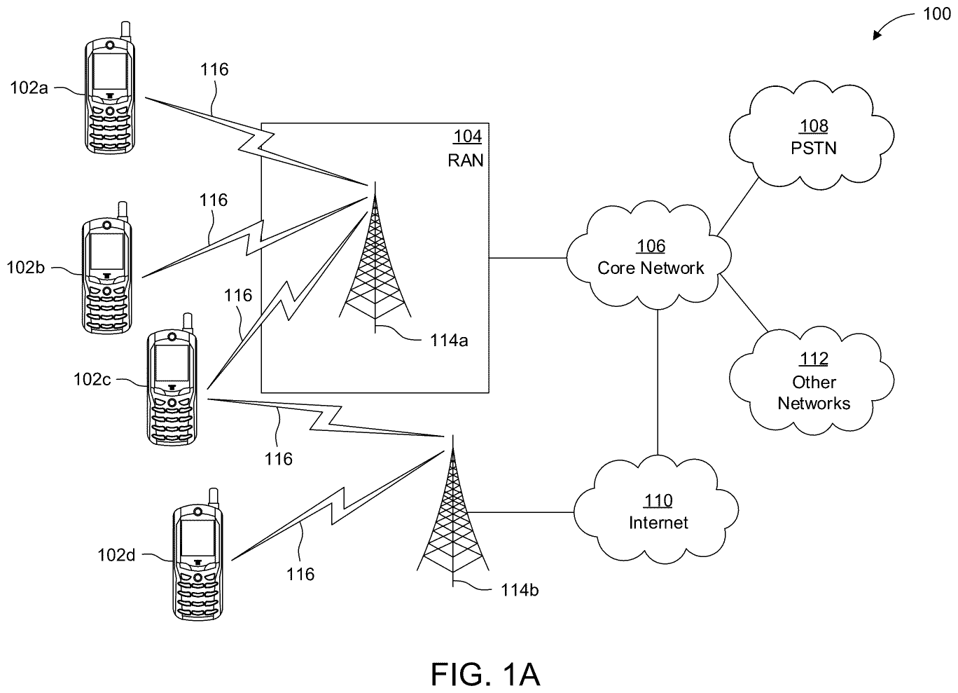

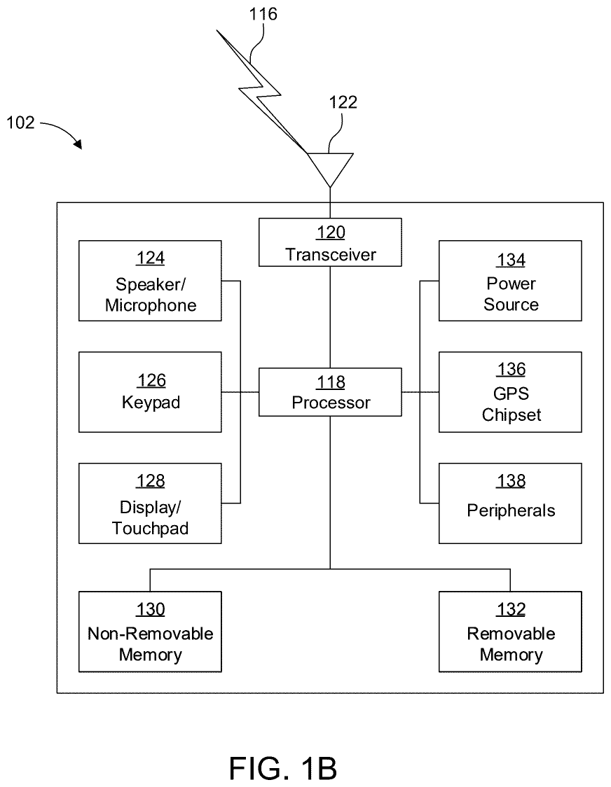

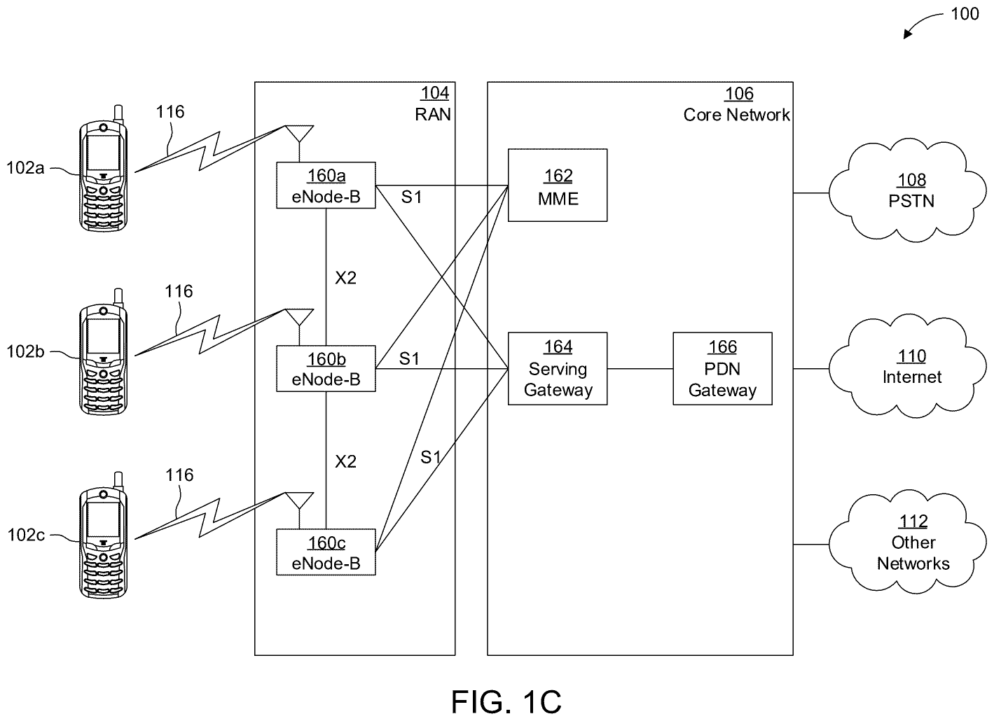

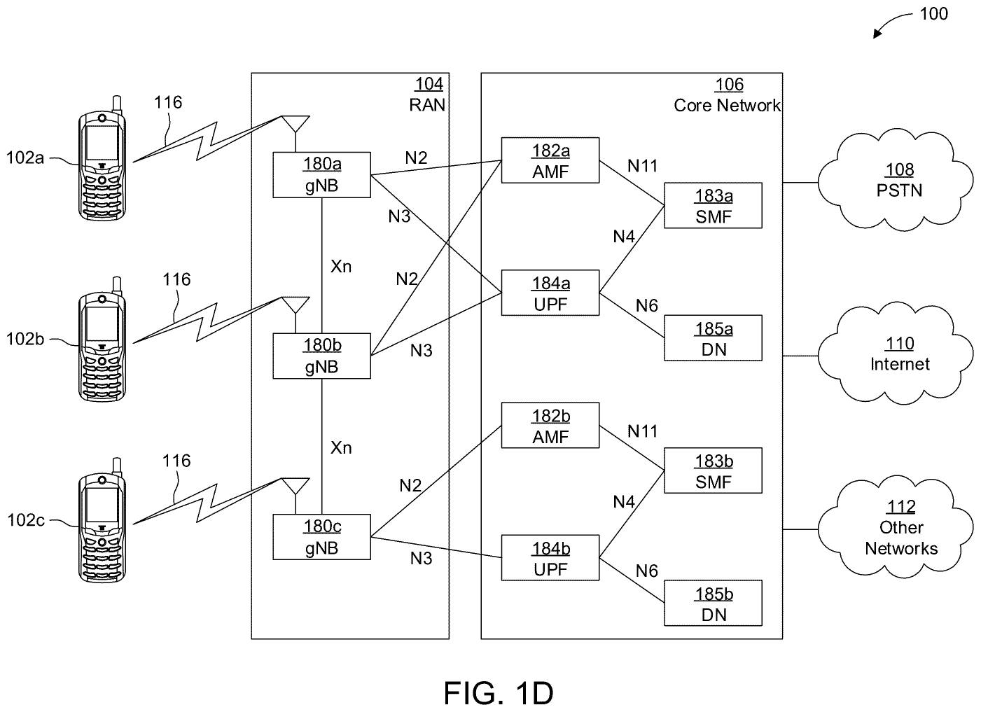

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discrete Fourier transform (DFT) Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (and/or a “STA”), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device (e.g., gaming devices), a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to, for example, facilitate access to one or more communication networks, such as the CN 106, the Internet 110, and/or the other networks 112. By way of example, the base stations 114a, 114b may be a base transceiver station (BTS), a Node B, an eNode-B (eNB), a Home Node-B (HNB), a Home eNode-B (HeNB, a next generation Node-B (NR NB), such as a gNode-B (gNB), a new radio (NR) Node-B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or Wi-Fi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 160a, 160b, 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, the gNBs 180a, 180b, 180c may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 182a, 182b may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

An AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off for a certain period of time before sensing again. One STA (e.g., only one station) may transmit at any given space, time and frequency resource in a given BSS.

In other representative embodiments, an AP may assign bandwidth resources over which associated STAs communicate with the AP. Bandwidth resources may include one or more channels (i.e., contiguous, or non-contiguous), one or more subchannels within a channel, one or more resource units (RUs) within an Orthogonal Frequency division Multiple Access (OFDMA) system, whereby assigned one or more RUs may be adjacent (i.e., contiguous) or non-contiguous, occupying one or more channels or subchannels, etc.

High Throughput (HT or 802.11n) STAs may use a 40 MHz wide channel for communication, for example, via a combination of the primary 20 MHz channel with an adjacent or nonadjacent 20 MHz channel to form a 40 MHz wide channel.

Very High Throughput (VHT or 802.11ac) STAs may support 20 MHz, 40 MHz, 80 MHz, and/or 160 MHz wide channels transmitted over a 5 GHz frequency band using OFDMA. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

High Efficiency Wireless (HEW or 802.11ax) STAs may support 20 MHz, 40 MHz, 80 MHz, and/or 160 MHz wide channels capable of transmission over 2.4 GHZ, 5 GHZ, and 6 GHz frequency bands using both OFDMA and multi-user multiple-input multiple-output (MU-MIMO) capabilities. OFDMA subcarrier modulation in HE STAs includes formats such as BPSK, QPSK, 16-QAM, 64-QAM, 256-QAM, 1024-QAM. The evolution of 802.11 to Extremely High Throughput (EHT) STAs extends to having 320 MHz wide channels.

While earlier generation 802.11 STAs (e.g., HEW or 802.11ax) could decide to transmit on one of the 2.4, 5.0, or 6 GHz bands, EHT STAs are further capable of multi-link operation (MLO), whereby data transmission between an EHT AP and non-AP STAs can occur over multiple bands simultaneously (e.g., 5 GHZ and 6 GHZ) thus increasing throughput and/or reliability. EHT STAs also benefit from a jump in QAM modulation from 1024-QAM to 4K-QAM, while enabling peak data rates of around 46 Gbps compared to the 9.6 Gbps capabilities of HEW STAs.

The next generation of 802.11 standard, 802.11bn (i.e., Ultra High Reliability-UHR) explores the possibility to improve reliability, support further reduced low latency traffic, further increase peak throughput, improved power saving capabilities and improve efficiency of the IEEE 802.11 network over HEW. These improvements are driven by technological advancements such as 360 immersive video, ultra-high-resolution streaming, online gaming, remote surgery, rapid expansion of Internet of Things (IoT), etc. Other 802.11 standard development examples are directed to areas such as: the application and management of artificial intelligence and machine learning (AIML) in WLANs, expanding WiFi communications into the millimeter-wave frequency band (integrated millimeter-wave—IMMW), energy harvesting based on of WiFi RF signals for facilitating WLAN communications of low-power IoT devices, and the randomization of MAC addresses in WLANs.

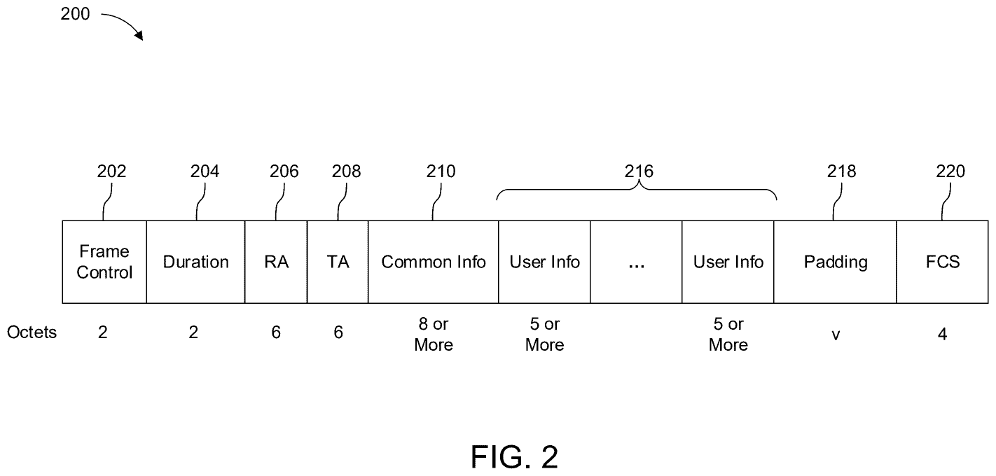

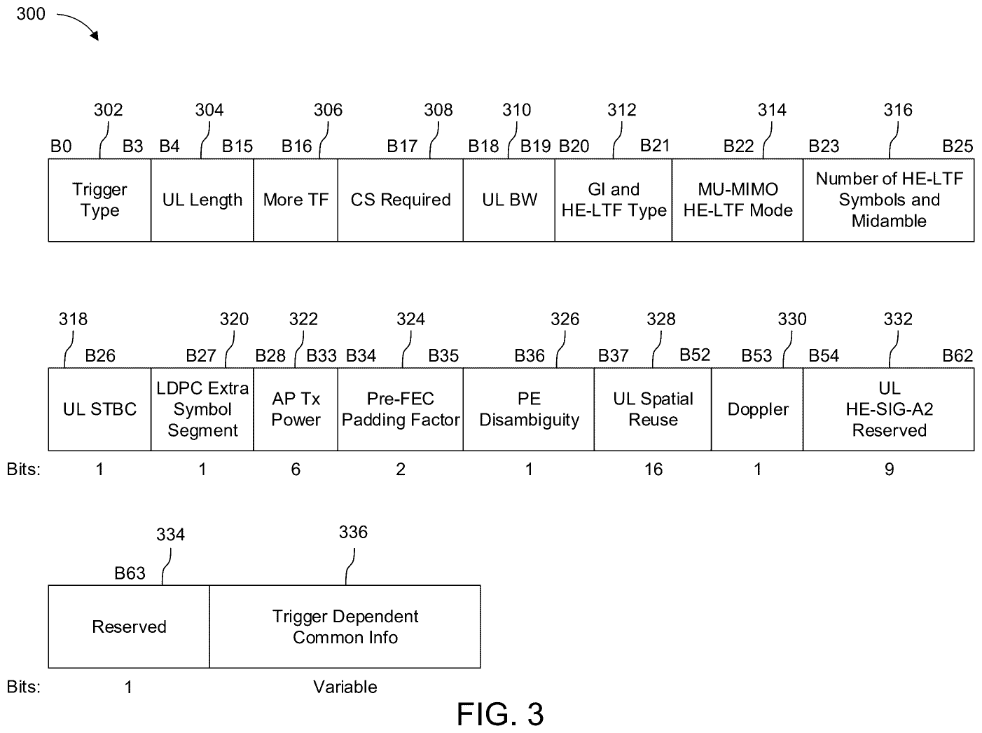

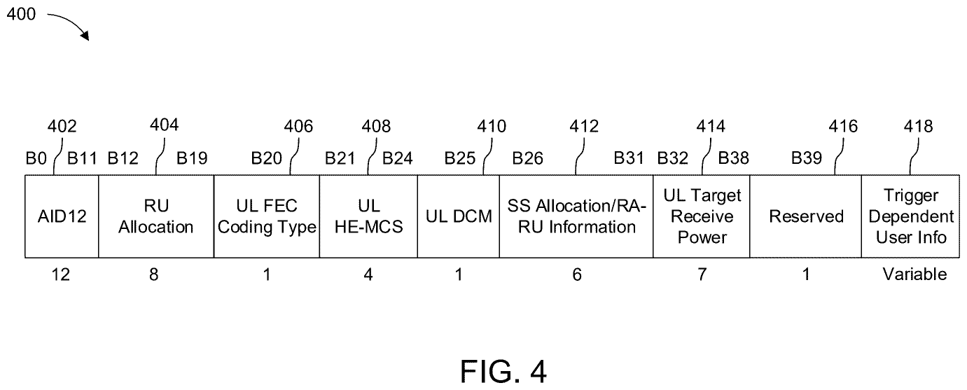

Procedures for trigger frame format design and signaling are disclosed herein to support various features such as unequal modulation (UEQM), distributed bandwidth resource unit (DRU), enhanced long range (ELR), power save, non-primary channel access (NPCA), multi-AP coordination, which may be included in 802.11 releases including 802.11bn. The trigger frame was first introduced to WiFi communications system in 802.11ax. Trigger frame may be used to allocate resources for the uplink transmission and may assist the non-AP STAs to synchronize their uplink transmissions in time domain, frequency domain, and/or power domain. FIG. 2 is a frame format diagram illustrating an example trigger frame 200 format. An example trigger frame 200 may include, but is not limited to, any of the following fields: frame control field 202; duration field 204; receiver address (RA) field 206; transmitter address (TA) field 208; common information (info) field 210; multiple user information (info) fields 216, such that each user information field corresponds to receiving STA; padding field 218; and/or frame check sequence (FCS) field 220. Example numbers of octets for each field are shown in FIG. 2 (“v” refers to a variable size). Example (sub) fields that may be included in common info field 210 are shown in FIG. 3, and example (sub) fields that may be included in each user info field 216 are shown in FIG. 4.

FIG. 3 is a frame format diagram illustrating an example common info field 300 format, which may be included in a trigger frame. The common info field 300 may include, but is not limited to, any of the following fields: trigger type field 302; UL length field 304; more trigger frame (TF) field 306; carrier sense (CS) required field 308; UL bandwidth (BW) field 310; guard interval (GI) and high efficiency long training field (HE-LTF) type field 312; MU-MIMO HE-LTF mode field 314; number of HE-LTF symbols and midamble field 316; UL space-time block code (STBC) field 318; low-density parity-check (LDPC) extra symbol segment field 320; AP transmit (Tx) power field 322; Pre-forward error correction (FEC) padding factor field 324; packet extension (PE) disambiguity field 326; UL spatial reuse field 328; doppler field 330; UL HE-SIG-A2 reserved field 332; reserved field 334; and/or trigger dependent common information (info) field 336. Example bit assignments including number of bits and order of bits (e.g., least significant bit (LSB) or most significant bit (MSB)) for each field are shown in FIG. 3. Example values of the trigger type subfield 302 in the common info field 300 is shown in Table 1 for 802.11be. In an example, a trigger type subfield value of “8” may be used for ranging, for example in 802.11az. In an example, the intended non-AP STAs may copy some information carried in the common info field 300 to the respective non-AP STAs high efficiency signal-A (HE-SIG-A) field so that HE-SIG-A fields in each UL trigger based (TB) physical protocol data units (PPDUs) are the same among multiple users.

FIG. 4 is a frame format diagram illustrating an example user info field 400 format, for which multiple may be included in a trigger frame. Each user info field 400 may be associated with a particular receiving non-AP STA. A user info field 400 may include, but is not limited to, any of the following fields: associate identifier 12 (AID12) field 402; resource unit (RU) allocation field 404; UL FEC coding type field 406; UL HE modulation and coding schedule (HE-MCS) field 408; UL dual carrier modulation (DCM) field 410; spatial stream (SS) allocation/random access resource unit (RA-RU) information field 412; UL target receive power field 414; reserved field 416; and/or a trigger dependent user info field 418. Example bit assignments including number of bits and order of bits (e.g., least significant bit (LSB) or most significant bit (MSB) for each field are shown in FIG. 3. For example, reserved field 416 is allocated to bit 39 “B39” in the user info field 400. In an example, the user info field 400 format may be used for any trigger type. In an example, the user info field 400 format may be used for any trigger type except Null Feedback Report Poll (NFRP) trigger type. The fields shown in FIGS. 2, 3 and 4 may be defined as described in various 802.11 standards.

TABLE 1
Example Trigger Type Values

| Trigger Type | |
|---|---|
| Subfield value | Trigger frame variant |
| 0 | Basic |
| 1 | Beamforming (BF) |
| | Report Poll (BFRP) |
| 2 | Multi-user blockAck |
| | request (MU-BAR) |
| 3 | Multi-user requested to |
| | send (MU-RTS) |
| 4 | Buffer Status Report |
| | Poll (BSRP) |
| 5 | Group cast with retries |
| | (GCR) MU-BAR |
| 6 | Bandwidth Query |
| | Report Poll (BQRP) |
| 7 | Null data packet (NDP) |
| | Feedback Report Poll |
| | (NFRP) |
| 8-15 | Reserved |

The trigger frame format has been updated in 802.11be so that it may carry information for to Extremely High Throughput (EHT) STAs, in order for EHT STAs to set universal signal (U-SIG) fields in the TB PPDU that is solicited by the trigger frame. The trigger frame for 802.11be may be designed so that a legacy STA (i.e., pre-EHT STA such as an 802.11ax HE STA) may understand the common info field and the user info field that is addressed to the legacy STA. For example, the trigger frame format in 802.11be may resemble the trigger frame 200 format of FIG. 2.

Under 802.11be, there may be three variants for a user info field of a trigger frame: special user info field; and HE variant user info field, and EHT variant user Info field. A special user info field may be a user info field that does not carry user specific information but carries extended common information not provided in the common info field. The special user info field may be identified by an AID12 value (e.g., a value of 2007). Zero, one or multiple special user info fields may be present in a trigger frame that is generated by an EHT AP.

In an example shown in Table 2, a set of valid combinations of bits B54 and B55 of the common Info field (see e.g., FIG. 3), and B39 in the user info field (see e.g., FIG. 4) may be used to indicate the following: the presence of the special user info field (which may or may not be present in the trigger frame), the variant of the user info field (e.g., HE or EHT) and the TB PPDU type that the receiving STA will use (e.g., HE or EHT).

TABLE 2
Example combinations of B54 and B55 in the common
info field, B39 in the user info field, used
to indicate the solicited TB PPDU format

| | | User | Presence | | |
|---|---|---|---|---|---|
| Common | Common | Info | of Special | | |
| Info field | Info field | field | User Info | User Info | |
| B54 | B55 | B39 | field | field variant | TB PPDU type |
| 1 | 1 | 0 | No | HE variant | HE |
| 0 | 0 | 0 | Yes | EHT variant | EHT |
| 0 | 0 | 1 | Yes | EHT variant | EHT |
| 1 | 0 | 1 | Yes | EHT variant | EHT |
| 1 | 0 | 0 | Yes | HE variant | HE |

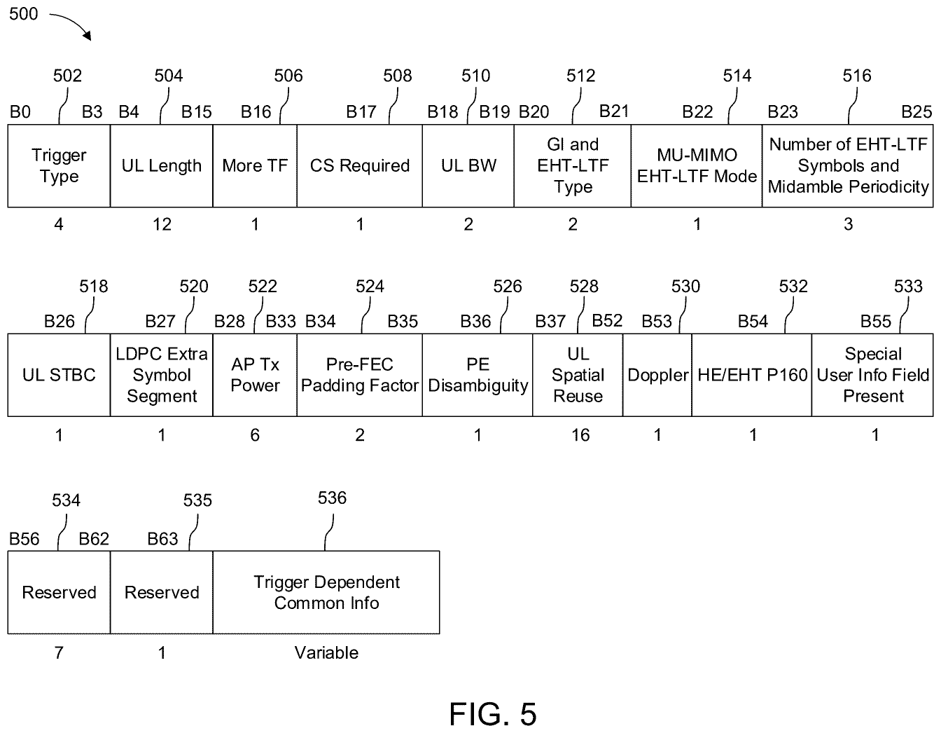

FIG. 5 is a frame format diagram illustrating an example EHT variant common info field 500 format, which may be included in a (e.g., EHT) trigger frame. The EHT variant common info field 500 may include, but is not limited to, any of the following fields: trigger type field 502; UL length field 504; more TF field 506; CS required field 508; UL BW field 510; GI and HE-LTF type field 512; MU-MIMO HE-LTF mode field 514; number of HE-LTF symbols and midamble field 516; UL STBC field 518; LDPC extra symbol segment field 520; AP Tx power field 522; Pre-FEC padding factor field 524; PE disambiguity field 526; UL spatial reuse field 528; doppler field 530; HE/EHT P160 field 532; special user info field present field 533; reserved field 534; reserved field 535; and/or trigger dependent common info field 536. Example bit assignments including number of bits and order of bits (e.g., B0, B1, . . . , B63, . . . ) for each field are shown in FIG. 5.

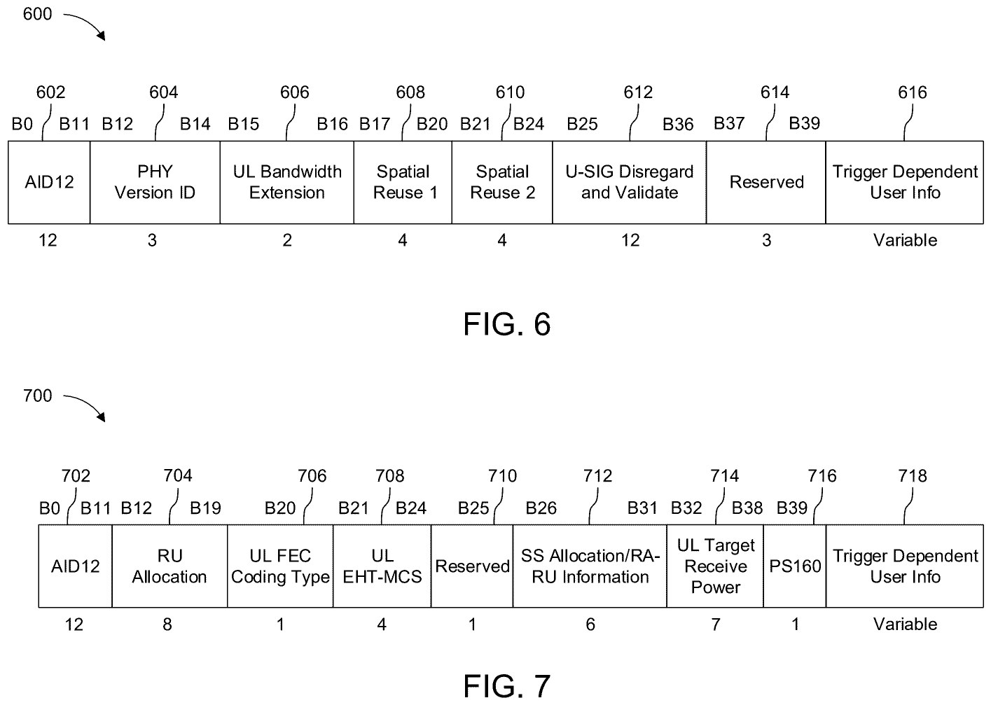

FIG. 6 is a frame format diagram illustrating an example special user info field 600 format, for which multiple may be included in a (e.g., EHT) trigger frame. A special user info field 600 may include, but is not limited to, any of the following fields: AID12 field 602; physical (PHY) version identifier (ID) field 604; UL bandwidth extension field 606; spatial reuse 1 field 608; spatial reuse 2 field 610; U-SIG disregard and validate field 612; reserved field 614; and/or a trigger dependent user info field 616. Example bit assignments including number of bits and order of bits for each field are shown in FIG. 6.

FIG. 7 is a frame format diagram illustrating an example EHT variant user info field 700 format, for which multiple may be included in a trigger frame. Each EHT variant user info field 700 may be associated with a particular receiving non-AP STA. An EHT variant user info field 700 may include, but is not limited to, any of the following fields: AID12 field 702; RU allocation field 704; UL FEC coding type field 706; UL EHT-MCS field 708; reserved field 710; SS allocation/RA-RU information field 712; UL target receive power field 714; PS160 field 716; and/or a trigger dependent user info field 718.

Example bit assignments including number of bits and order of bits for each field are shown in FIG. 7. The fields shown in FIGS. 5, 6, and 7 may be defined as described for example in the 802.11be standard.

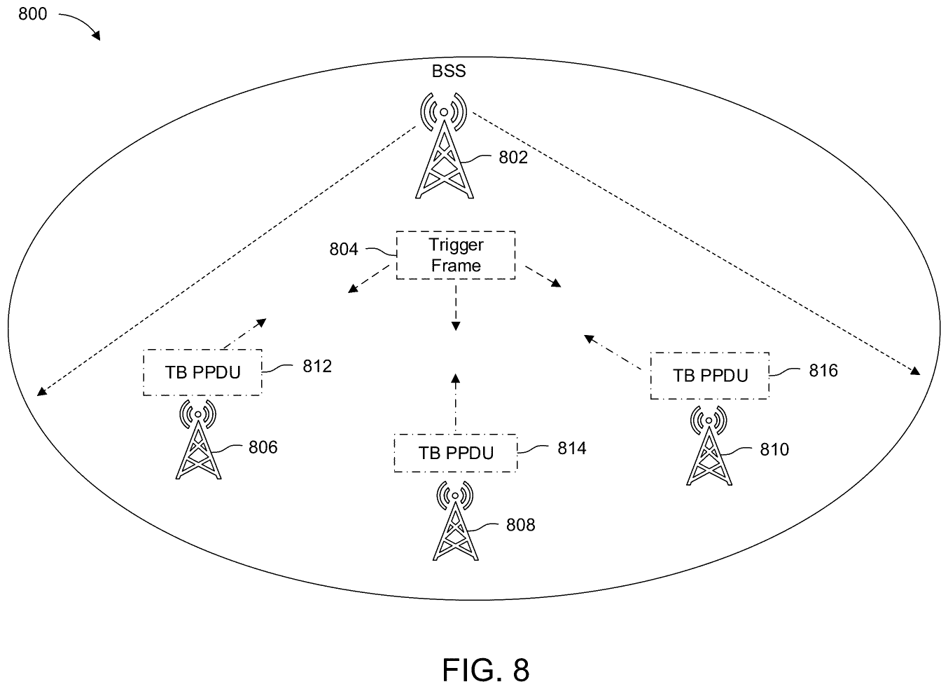

As stated previously, trigger frames are used to allocate resources for uplink transmissions, while enabling non-AP STAs to synchronize their uplink transmissions in time, frequency, and/or power domain. FIG. 8 is a system diagram illustrating an example wireless communication system 800 where a trigger frame 804 is used to trigger TB PPDUs 812, 814, and 816. Referring to FIG. 8, a STA 802 (e.g., AP or non-AP STA) may transmit a trigger frame 804 to multiple STAs such as STAs 806, 808, and 810. The STAs 806, 808, 810 may support different 802.11 variants (i.e., Wi-Fi versions/generations) such as, for example, HE (802.11ax), EHT (802.11be), UHR (802.11bn), and beyond (versions/generations beyond 802.11bn). Accordingly, the receiving STAs 806, 808, 810 may need to respectively distinguish the different variants (e.g., HE, EHT, UHR, etc.) signaled in the received trigger frame 804 in order to read the variant information applicable to them in the trigger frame 804. Each STA 806, 808, 810 may then transmit a respective TB PPDU based on distinguishing its corresponding variant from the information and reading the variant-based information indicated in the received trigger frame 804. For example, STA 806 may respond to the received trigger frame 804 by transmitting a HE type TB PPDU 812, while STA 808 may respond to the received trigger frame 804 by transmitting a EHT type TB PPDU 814. According to another example, STA 810 may respond to the received trigger frame 804 by transmitting a UHR type TB PPDU 816.

IEEE 802.11 UHR, formed by the UHR or 802.11bn Study Group (TGbn group), is considered as the next major revision to IEEE 802.11 standards following 802.11be (or EHT). UHR explores the possibility to improve reliability, support further reduced low latency traffic, further increase peak throughput, improve power saving capabilities, and improve efficiency of the IEEE 802.11 network over EHT. For example, a goal of 802.11bn is to reach speeds of 100 Gbps.

The following features are defined for 802.11bn: unequal modulation (UEQM) over different spatial streams; distributed-tone resource unit (dRU) allocation for TB PPDU transmissions; Enhanced Long Range (ELR) PPDU mechanisms; other range extension mechanisms; LDPC codeword lengths larger than 1944, including 2×1944; power save mode for a STA that is a UHR Mobile AP or a UHR non-AP STA wherein the STA may transition from a lower capability mode to a higher capability mode upon reception of an initial control frame; mode of operation that enables a STA to access the secondary channel while the primary channel is known to be busy due to overlapping BSS (OBSS) traffic or other conditions; and/or Multi-AP coordinated transmissions including coordinated spatial reuse (C-SR) and coordinated beamforming (C-BF).

802.11bn defines new PHY and MAC features that may need updates to PPDU content and/or format including MU PPDU and TB PPDU. According to example embodiments described herein, the trigger frame that solicits the TB PPDU may be modified to trigger concurrent uplink OFDMA or MU-MIMO transmissions from UHR STAs and to correspond to the new format of TB PPDU. The trigger frame that solicits the TB PPDUs may follow the existing frame format that includes common Info field and user info fields. The common info field may have an HE variant, an EHT variant, and a UHR variant. The user info fields may include special user info field(s), a HE variant user info field(s), EHT variant user info field(s), and/or UHR variant user info field(s). The special user info field may include EHT variant special user info field and/or UHR variant special user info field. A receiving STA (e.g., an HE STA, an EHT STA, or a UHR STA) may need to distinguish the different variants of the trigger frames, common info fields and user info fields in order to read the corresponding information. Additionally, the trigger frame should be designed with backwards compatibility such that legacy STAs (i.e., pre-UHR STAs including non-UHR HE STAs and non-UHR EHT STAs) may partially understand the trigger frame transmitted by a UHR AP.

For the example embodiments described herein, the following example terminology may be used to refer different 802.11 amendments/generations: 802.11ax may be referred to as High Efficiency (HE); 802.11be may be referred to as Extremely High Throughput (EHT); and 802.11bn may be referred to as Ultra High Reliability (UHR). A STA with a newer or later generation of 802.11 standard may be considered backwards compatible and thus capable of a receiving packets and variants of a previous generation. For example, a UHR STA may also function as an EHT STA and HE STA. In contrast, an HE STA may not necessarily be able to function as an EHT STA or UHR STA. To clarify intended meaning, the following example terminology is also used herein: Non-EHT HE STA or pre-EHT HE STA may refer to a STA that is an HE STA but not an EHT STA; a Non-UHR EHT STA may refer to a STA that is an EHT STA but not an UHR STA. In example terminology used herein, UHR+ may refer to an 802.11 amendment later than UHR/802.11bn (e.g., a future 802.11 generation). Similarly, EHT+ may refer to an 802.11 amendment later than EHT/802.11be.

Example embodiments may use a trigger variant indication for determining a variant of a TB PPDU. According example procedures, an AP, that intends to trigger UHR/UHR+ TB PPDU transmissions, may transmit a trigger frame with the EHT variant common Info field. In an example, the EHT variant common Info field may be modified and renamed as EHT+ variant common Info field or UHR variant common Info field. Trigger frame and TB transmission may be used to trigger communications between multiple APs. In that case, a UHR AP may be a potential recipient of a trigger frame. In this case, the user info field may be addressed to an AP with UHR variant. In an example, a STA (e.g., non-AP STA or AP STA) may check a set of bits the common Info field of the Trigger frame to determine the variant of the Common Info field. In particular, the STA may check the 54th bit and 55th bit (B54 and B55) of the common Info field of the trigger frame to determine the variant of the common Info field.

According an example procedure, an AP, that intends to trigger UHR/UHR+ TB PPDU transmissions, may transmit a trigger frame including a special user info field that may be considered a type of “UHR variant” special user info field including the special PHY Version ID field. Table 3 provides example values for using bits B54 and B55 of a common info field, B39 of a user info field associated with the receiving STA, and the PHY version ID field of the special user info field in a trigger frame to indicate the variant of a common info field in a trigger frame.

With reference to Table 3, the common info field variant in the trigger frame may have an HE variant and an EHT variant. The user info fields may include special user info field, HE variant, EHT variant, and UHR variant. The special user info field, if present, may have an EHT variant and UHR variant. In an example, zero or one special user info field may be included in a trigger frame. This method may be used to solicit aggregated HE TB PPDUs and UHR TB PPDUs. For an EHT variant common info field, a field such as bits in a reserved field (e.g., any of bits B56 to B63 in example EHT common info field 500 of FIG. 5) may be used to signal information for UHR/UHR+ STAs.

UHR and UHR+ STAs that receive the trigger frame with an EHT variant common info field may interpret bit B54 in the EHT variant common info field as an HE/EHT+ P160 subfield (e.g., HE/EHT P160 field 532 in FIG. 5). In an example, the HE/EHT+ P160 subfield bit set to ‘1’ may mean that the primary 160 MHz channel is allocated for HE TB PPDU transmission. The HE/EHT+ P160 subfield bit is set to ‘0’ may mean the primary 160 MHz channel is allocated for EHT or EHT+ TB PPDU transmission. The special user info field present field (e.g., B55 in FIG. 5) in the common info field of a trigger frame may indicate the presence or absence of the special user info field. A pre-EHT HE STA (i.e., non-UHR non-EHT HE STA) that receives the trigger frame with an EHT variant common info field may interpret the common info field as an HE variant common info field. An EHT/EHT+ STA that receives the trigger frame with an EHT variant common info field may interpret the common info field as an HE variant common info field for a first bit pattern of certain bits (e.g., “selection” bits) of the common info field, where the certain bits may be for example bits B54 and B55 of the common info field and the first bit pattern may be that the values of B54 and B55 are both equal to ‘1’. Otherwise, when B54 and B55 do not have the first bit pattern (e.g., values ‘11’), an EHT/EHT+ STA that receives the trigger frame with an EHT variant common info field may interpret the common info field as an EHT variant common info field.

In an example, UHR/UHR+ specific information may be carried in the UHR variant special user info field and UHR variant user info field. A UHR variant special user info field may be identified by detecting the values of a field or a combination of fields. A pre-EHT HE STA (or non-EHT HE STA) may interpret the special user info field as a user info field not addressed to itself.

In an example, The PHY Version ID subfield carried in the special user info field may be set to a value greater than ‘0’ to indicate the special user info field is a UHR or UHR+ variant special info field. For example, the PHY version ID subfield may be set to ‘1’ to indicate a UHR variant special user info field. Non-UHR EHT STAs may interpret any value of greater than ‘0’ for the PHY version ID field is invalid and as such may discard the information carried by the special user info field. UHR STAs, which do not support any amendment later than UHR, may interpret any value greater than 1 for the PHY version ID field is invalid. In this way, when the PHY version ID subfield is set to 1, a non-UHR EHT STA (i.e., an EHT STA which is not a UHR STA) may interpret the special user info field as an EHT variant special user info field. By checking the PHY Version ID subfield being set to an invalid value, a non-UHR EHT STA may determine that the special user info field is not for EHT STAs and the non-UHR EHT STA may discard the information carried in the special user info field. A UHR STA, which does not support any amendment later than UHR, may interpret the special user info field as a UHR variant special user info field. When the PHY version ID subfield is set to a value greater than ‘1’, a non-UHR EHT STA (i.e., an EHT STA which is not a UHR STA) or a UHR STA that does not support later 802.11 amendment may determine a version violation by checking the PHY version ID subfield being set to an invalid value. In this case, the non-UHR EHT STA or a UHR STA may discard the information carried in the special user info field.

A trigger frame including an EHT variant special user info field as described herein may trigger HE TB PPDUs or EHT TB PPDUs. A trigger frame including an UHR variant special user info field as described herein may trigger HE TB PPDUs or UHR TB PPDUs. In the examples solutions described herein, including in Table 3, particular fields including bits B54 and B55 of the common info field, B39 of the user info field, and PHY version ID field of the special user info field are used, and it is understood that other bits, numbers of bits and fields may be used.

In an example, a user info field that is addressed to a STA may be an HE variant or an EHT variant or a UHR variant. The user info field may be an HE variant addressed to a non-UHR EHT STA if a particular bit (e.g., B39) of the user info field is set to ‘0’ and a particular bit (e.g., B54) of the common info field is set to ‘1’ in the trigger frame; otherwise, the user info field is an EHT variant. The user info field may be an HE variant addressed to a UHR STA (e.g., UHR non-AP STA or UHR AP STA) if B39 of the user info field is set to ‘0’ and B54 of the common info field is set to ‘1’ in the trigger frame; otherwise, the user info field may be a UHR variant. The user info field may be a UHR variant addressed to a UHR STA (e.g., UHR non-AP STA or UHR AP STA) if bit B39 of the user info field is set to ‘1’ and bit B54 of the common info field is set to ‘1’, and the PHY version ID subfield of the special user info field is set to ‘1’ (or indicating UHR PHY version) in the trigger frame. Bit B39 of an HE variant user info field may be reserved for a non-EHT HE STA (e.g., reserved field 416 in FIG. 4). Bit B39 may be set to ‘0’ for an HE variant user info field by an EHT AP or a UHR AP. Bit B39 may be the PS160 subfield for an EHT/UHR variant user Info field (e.g., PS160 field 716 in FIG. 7). Bit B54 in EHT variant common Info field may be the HE/EHT P160 subfield (e.g., HE/EHT P160 field 532 in FIG. 5), which indicates whether the solicited TB PPDU in the primary 160 MHz channel is an HE TB PPDU or EHT/EHT+ TB PPDU. Bit B55 in EHT variant common info field may be the special user info field flag subfield (e.g., special user info field flag field 533 in FIG. 5), which indicates whether or not the special user info field is present in the trigger frame.

Table 3 defines example valid combinations of values of all of B54 and B55 in the common info field, B39 in the user info field, PHY version ID field in the special user info field, the presence of the special user info field in the trigger frame, and the variant of a user info field, and the corresponding TB PPDU type that receiving STA will transmit based on the values. When the user info field is identified as a UHR variant user info field, the UHR STA addressed by the user info field may respond with a UHR TB PPDU. The last two rows of Table 3 may solicit aggregated HE and UHR TB PPDU. B54 in common info field set to ‘1’ indicates the TB PPDU in the primary 160 MHz channel is an HE TB PPDU. B55 in common info field set to ‘0’ indicates the presence of the special user info field. The PHY Version ID subfield in the special user info field set to ‘1’ indicates a UHR variant of special user info field. B39 in one or more user info fields set to ‘0’ indicates that the user info fields are HE variant user info field, and the corresponding RUs allocated to the users are located in the primary 160 MHz channel. B39 in one or more user info fields set to ‘1’ indicates the user info fields are UHR variant user info field, and the corresponding RUs allocated to the users are located in the non-primary 160 MHz channel.

TABLE 3
Example values for using B54 and B55, B39 and PHY Version ID to indicate
and determine the variant of a common info field in a trigger frame

| | | | | | | PHY | | |
|---|---|---|---|---|---|---|---|---|
| | | | | Common Info | Common Info | Version ID | | |
| | | | Special | field variant | field variant | in Special | User | TB |
| Common Info | Common Info | User Info | User Info | for pre-EHT | for EHT/ | User Info | Info field | PPDU |
| field B54 | field B55 | field B39 | field | HE STA | EHT+ STA | field | variant | type |
| 1 | 1 | 0 | Not | HE variant | HE variant | N/A | N/A | N/A |
| | | | present | | | | | |
| 0 | 0 | 0 | EHT | HE variant | EHT variant | 0 | EHT | EHT |
| | | | variant | | | | | |
| 0 | 0 | 1 | EHT | HE variant | EHT variant | 0 | EHT | EHT |
| | | | variant | | | | | |
| 1 | 0 | 1 | EHT | HE variant | EHT variant | 0 | EHT | EHT |
| | | | variant | | | | | |
| 1 | 0 | 0 | EHT | HE variant | EHT variant | 0 | HE | HE |
| | | | variant | | | | | |
| 0 | 0 | 0 | UHR | HE variant | EHT variant | 1 | UHR | UHR |
| | | | variant | | | | | |
| 0 | 0 | 1 | UHR | HE variant | EHT variant | 1 | UHR | UHR |
| | | | variant | | | | | |
| 1 | 0 | 1 | UHR | HE variant | EHT variant | 1 | UHR | UHR |
| | | | variant | | | | | |
| 1 | 0 | 0 | UHR | HE variant | EHT variant | 1 | HE | HE |
| | | | variant | | | | | |

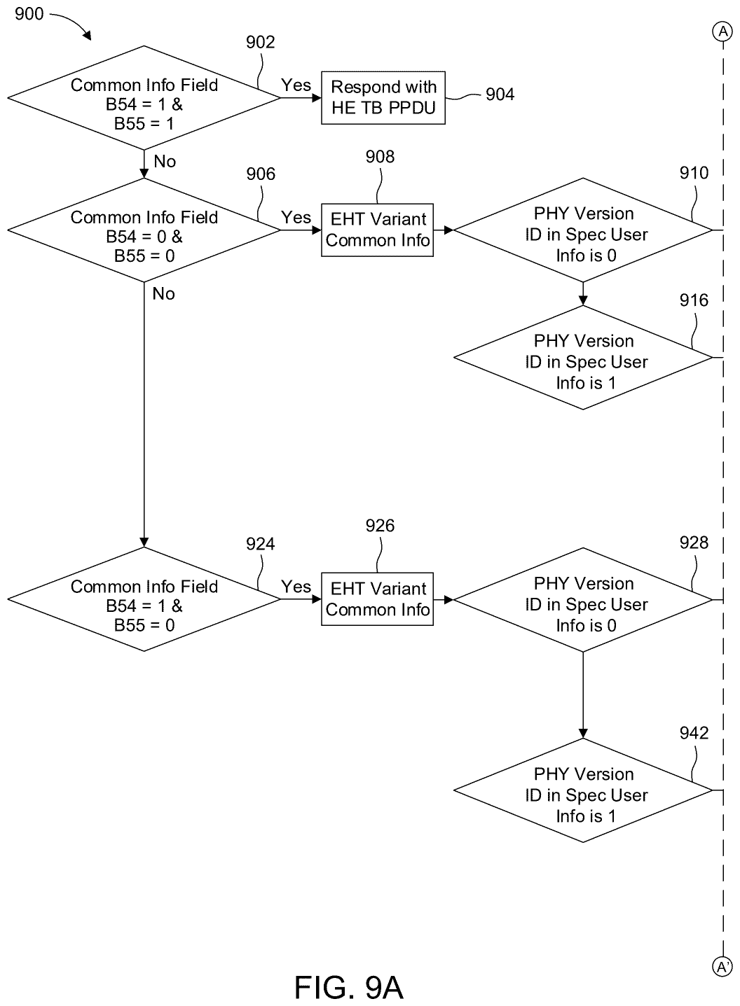

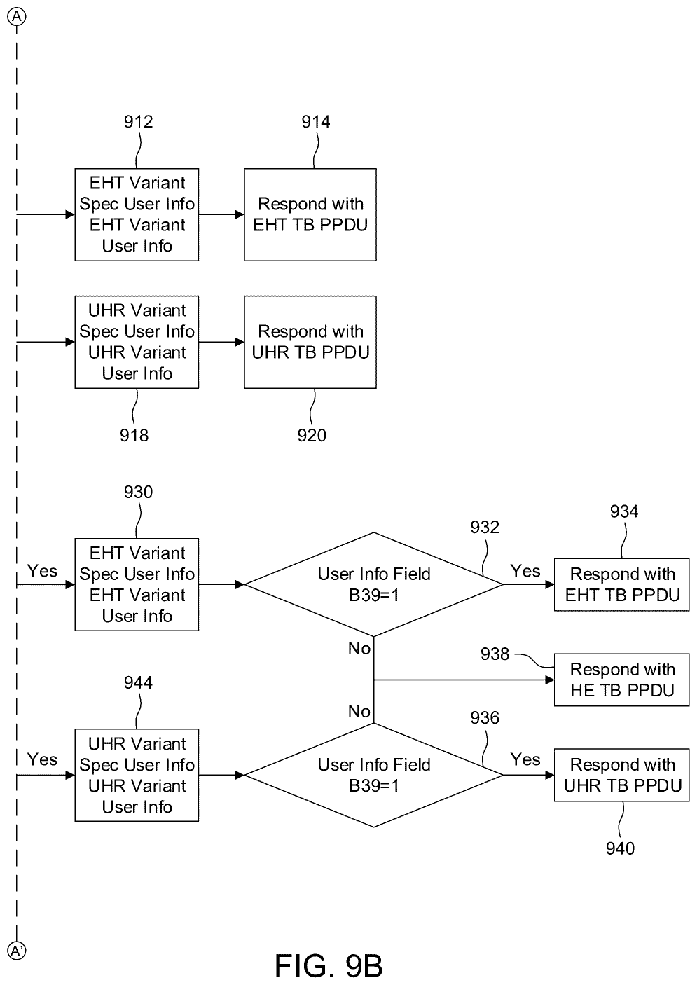

FIGS. 9A and 9B are a flow diagram illustrating an example procedure 900 for determining a TB PPDU variant, performed by a STA that is a UHR or UHR+ STA, in response to receiving a trigger frame, from an AP, that includes a user info field addressed to the STA. The STA may check bits B54 and B55 in the common info field. At 902, if B54=1 and B55=1, then the STA may consider the common Info field as an HE variant common Info field. In this case, the special user info field may not be present. The user info field addressed to the STA is an HE variant user info field. At 904, the STA may respond to the trigger frame by transmitting, to the AP, an HE TB PPDU (i.e., based on the determined HE variant).

Otherwise, at 906, if B54=0 and B55=0, then, at 908, the STA may consider the common info field as an EHT variant common info field. In this case, the special user info field may not be present. At 910, if the PHY version ID field in the special user info field is ‘0’, then, at 912, special user info field is determined to be an EHT variant special user info field. The user info field addressed to the STA is an EHT variant user info field. At 914, the STA may respond to the trigger frame by transmitting, to the AP, an EHT TB PPDU (i.e., based on the determined EHT variant). At 916, if the PHY version ID in the special user Info field is ‘1’, then at 918, the special user info field is determined to be a UHR variant special user info field. The user info field addressed to the STA is a UHR variant user info field. At 920, the STA may respond to the trigger frame by transmitting, to the AP, a UHR TB PPDU (i.e., based on the determined UHR variant). Other values of the PHY version ID in the special user info field may be used for variants associated with future generation(s).

Otherwise, at 924, if B54=1 and B55=0, then, at 926, the STA may consider the common info field as an EHT variant common info field. In this case, the special user info field is present in the trigger frame. This setting may be used to enable A-PPDU transmissions as needed. At 928, if the PHY version ID field in the special user info field is ‘0’, then, at 930, the STA determines that the special user info field is an EHT variant special user info field. The user info field addressed to the STA is an EHT variant user info field. At 932, if the bit B39 of the user info field is set to ‘1’, the STA at 934 may respond to the trigger frame by transmitting, to the AP, an EHT TB PPDU (i.e., based on the determined EHT variant). Otherwise if the bit B39 of the user info field is set to ‘0’, the STA at 938 may respond to the trigger frame by transmitting, to the AP, an HE TB PPDU. At 942, if the PHY version ID field in the special user info field is ‘1’, then, at 944, the STA determines that the special user info field is a UHR variant special user info field. The user info field addressed to the STA is a UHR variant user info field. At 936, if the bit B39 of the user info field is set to ‘1’, the STA may at 940 respond to the trigger frame by transmitting, to the AP, a UHR TB PPDU (i.e., based on the determined UHR variant). Otherwise, if the bit B39 of the user info field is set to ‘0’, the STA may at 938 respond to the trigger frame by transmitting, to the AP, an HE TB PPDU (i.e., based on the determined HE variant). The PHY Version ID in the Special User Info field may be set to other values for a future generation. B54=0 and B55=1 is reserved or invalid combination. This method may be extended to a future generation of 802.11 easily by setting the PHY Version ID to a value greater than 1. In an example, the bits B54=0 and B55=1 may not be used or may be considered invalid.

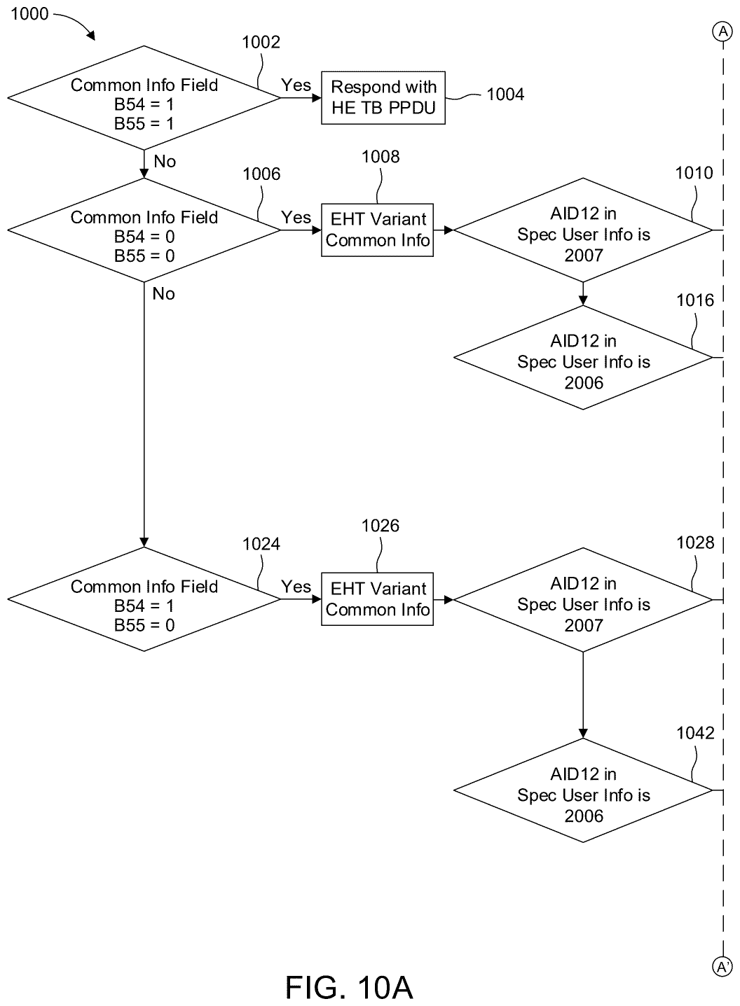

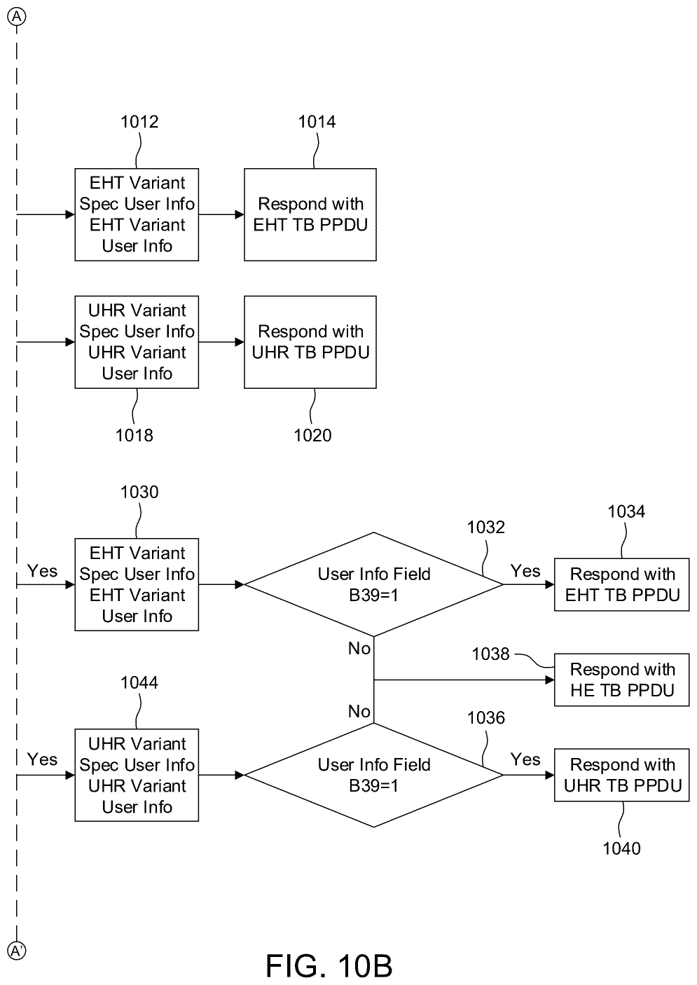

According an example procedure, an AP, that intends to trigger UHR/UHR+ TB PPDU transmissions, may transmit a trigger frame including a UHR variant special user info field with a special AID field, as illustrated in FIGS. 10A and 10B. FIGS. 10A and 10B are a flow diagram illustrating another example procedure 1000 for determining a TB PPDU variant, performed by a STA that is a UHR or UHR+ STA, in response to receiving a trigger frame, from an AP, that includes a user info field addressed to the STA. In the example procedure 1000, and corresponding Table 4, the common info field in the trigger frame may have HE variant and EHT variant. The user info field may include a special user info field, HE variant, EHT variant and UHR variant. The special user info field if present, may have EHT variant and UHR variant. In an example, zero or one special user info field may be included in the trigger frame, which may be used to solicit aggregated HE TB PPDUs and UHR TB PPDUs. With EHT variant common info field, currently reserved bits such as B56 to B63 may be used to signal information for UHR/UHR+ STAs. In procedure 1000, the methods used to distinguish HE variant common info field and EHT variant common info field may be the same as in procedure 900 if FIGS. 9A and 9B. In other words, steps 1002, 1004, 1006, 1008, 1024, and 1026, correspond respectively to steps 902, 904, 906, 908, 924, and 926 in FIGS. 9A and 9B.

UHR/UHR+ specific information may be carried in the UHR variant special user info field and UHR variant user info field. A pre-EHT HE STA (or non-EHT HE STA) may interpret the special user info field as a user info field not addressed to itself.

In an example, AID12 subfield carried in the special user info field may be set to a current reserved value or a specific value (e.g., other than ‘2007’, ‘2045’, ‘2046’, ‘4095’) to indicate the special user info field is a UHR or UHR+ variant special user info field. At 1010, if an AID12 field in the special user info field with a value of ‘2007’, then, at 1012, special user info field is determined to be an EHT variant special user info field. The user info field addressed to the STA is an EHT variant user info field. At 1014, the STA may respond to the trigger frame by transmitting, to the AP, an EHT TB PPDU (i.e., based on the determined EHT variant). At 1016, if the AID 12 subfield value is ‘2006’, then at 1018, the special user info field is determined to be a UHR variant special user info field. The user info field addressed to the STA is a UHR variant user info field. At 1020, the STA may respond to the trigger frame by transmitting, to the AP, a UHR TB PPDU (i.e., based on the determined UHR variant).

At 1024, if B54=1 and B55=0, then, at 1026, the STA may consider the common info field as an EHT variant common info field. In this case, the special user info field is present in the trigger frame. This setting may be used to enable A-PPDU transmissions as needed. At 1028, if the AID12 field in the special user info field is ‘2007’, then, at 1030, the STA determines that the special user info field is an EHT variant special user info field. The user info field addressed to the STA is an EHT variant user info field. At 1032, if the bit B39 of the user info field is set to ‘1’, the STA at 1034 may respond to the trigger frame by transmitting, to the AP, an EHT TB PPDU (i.e., based on the determined EHT variant). Otherwise if the bit B39 of the user info field is set to ‘0’, the STA at 1038 may respond to the trigger frame by transmitting, to the AP, an HE TB PPDU. At 1042, if the AID12 field in the special user info field is ‘1’, then, at 1044, the STA determines that the special user info field is a UHR variant special user info field. The user info field addressed to the STA is a UHR variant user info field. At 1036, if the bit B39 of the user info field is set to ‘1’, the STA may at 1040 respond to the trigger frame by transmitting, to the AP, a UHR TB PPDU (i.e., based on the determined UHR variant). Otherwise, if the bit B39 of the user info field is set to ‘0’, the STA may at 1038 respond to the trigger frame by transmitting, to the AP, an HE TB PPDU (i.e., based on the determined HE variant). The PHY Version ID in the Special User Info field may be set to other values for a future generation. B54=0 and B55=1 is reserved or invalid combination. This method may be extended to a future generation of 802.11 easily by setting the PHY Version ID to a value greater than 1. In an example, the bits B54=0 and B55=1 may not be used or may be considered invalid. The AID12 subfield in the Special User Info field may be set to other values for future generations. B54=0 and B55=1 is reserved or invalid combination. This method may be extended to a future generation of 802.11 easily by setting the AID12 subfield in the special user info field to another predefined value (e.g., ‘2005’). AID value of ‘2006’ is used herein as an example, and may be set to other values to indicate the UHR variant.

The AID value may not be assigned to identify any STA by a UHR AP. In this way, A non-UHR EHT STA may interpret the special user info field as user info field that is not addressed to the STA. Non-UHR EHT STAs may disregard information carried by the UHR variant special user info field. UHR STAs may understand this is a UHR variant special info field that carries UHR specific information. In an example, the PHY version ID field in the UHR variant special user Info may be set to any value. For example, the PHY version ID field may be set to ‘0’ to indicate the solicited TB PPDU is an EHT variant TB PPDU even though the special user info field is a UHR variant. In an example, the PHY version ID field in the UHR variant special user info may be set to indicate UHR PHY version.

In the example procedure 1000, when an EHT variant special user info field is included, HE TB PPDUs or EHT TB PPDUs may be triggered. When an UHR variant special user info field is included, HE TB PPDUs or EHT TB PPDU or UHR TB PPDUs may be triggered.

As shown in the example procedures 900 and 1000 of FIGS. 9A, 9B, 10A and 10B, A user info field that is addressed to a STA may be an HE variant or an EHT variant or a UHR variant. The user Info field is an HE variant addressed to a non-UHR EHT STA if B39 of the User Info field is set to 0 and B54 of the Common Info field is set to 1 in the Trigger frame; otherwise, it is an EHT variant. The User Info field is an HE variant addressed to a UHR STA (e.g., UHR non-AP STA or UHR AP STA) if B39 of the User Info field is set to 0 and B54 of the Common Info field is set to 1 in the Trigger frame; otherwise, it is a UHR variant. Or the User Info field is a UHR variant addressed to a UHR STA (e.g., UHR non-AP STA or UHR AP STA) if B39 of the User Info field is set to 1 and B54 of the Common Info field is set to 1, and the AID 12 subfield of the Special User Info field is set to indicate a UHR variant Special User Info field in the Trigger frame.

B39 of an HE variant User Info field is reserved for a non-EHT HE STA. B39 is set to 0 for an HE variant User Info field by an EHT AP or an UHR AP. B39 is the PS160 subfield for an EHT/UHR variant User Info field. B54 in EHT variant Common Info field is the HE/EHT P160 subfield, which indicates the whether the solicited TB PPDU in the primary 160 MHz channel is a HE TB PPDU or EHT/EHT+ TB PPDU. B55 in EHT variant Common Info field is the Special User Info Field Flag subfield, which indicates if the Special User Info field present in the Trigger frame.

Table 4 shows example valid combinations of B54 and B55 in the common info field, bit B39 of the user info field, AID 12 of the special user info field, the presence of the special user info field in the trigger frame, the variant of a user info field, and the corresponding TB PPDU type. When the user info field is identified as a UHR variant user info field, the UHR STA address by the user info field may respond with a UHR TB PPDU.

The last two rows of Table 4 may solicit aggregated HE and UHR TB PPDU. Bit B54 in common info field being set to a value of ‘1’ may indicate that the TB PPDU in the primary 160 MHz channel is an HE TB PPDU. Bit B55 in common info field set to a value of ‘0’ may indicate the presence of the special user info field. The AID12 subfield of the special user info field set to a value of ‘2006’ may indicate a UHR variant of special user info field. Bit B39 in one or more user info fields being set to ‘0’ may indicate that the user info fields are HE variant user info fields, and the corresponding RUs allocated to the STAs are in the primary 160 MHz channel. Bit B39 in one or more user info fields being set to a value of ‘1’ may indicate that the user info fields are UHR variant user info fields, and the corresponding RUs allocated to the users are located in the non-primary 160 MHz channel.

TABLE 4
Example values for using B54 and B55, B39 and AID12 to indicate and
determine the variant of the common info field in a trigger frame

| | | | Special | Presence of | AID12 in | User Info | TB |
|---|---|---|---|---|---|---|---|
| Common Info | Common Info | User Info | User Info | Special User | Special User | field | PPDU |
| field B54 | field B55 | field B39 | field | Info field | Info field | variant | type |
| 1 | 1 | 0 | Not present | No | N/A | HE | HE |
| 0 | 0 | 0 | EHT | Yes | 2007 | EHT | EHT |
| | | | variant | | | | |
| 0 | 0 | 1 | EHT | Yes | 2007 | EHT | EHT |
| | | | variant | | | | |
| 1 | 0 | 1 | EHT | Yes | 2007 | EHT | EHT |
| | | | variant | | | | |
| 1 | 0 | 0 | EHT | Yes | 2007 | HE | HE |
| | | | variant | | | | |
| 0 | 0 | 0 | UHR | Yes | 2006 | UHR | UHR |
| | | | variant | | | | |
| 0 | 0 | 1 | UHR | Yes | 2006 | UHR | UHR |
| | | | variant | | | | |
| 1 | 0 | 1 | UHR | Yes | 2006 | UHR | UHR |
| | | | variant | | | | |
| 1 | 0 | 0 | UHR | Yes | 2006 | HE | HE |
| | | | variant | | | | |

According an example procedure, an AP, that intends to trigger UHR/UHR+ TB PPDU transmissions, may transmit a trigger frame including a UHR variant common info field. In an example, the common info field in the trigger frame may have HE variant, EHT variant and UHR variant. The user Info field may have special user info field, HE variant, EHT variant and UHR variant. The special user info field, if present, may have EHT variant and UHR variant. This method may be used to solicit aggregated HE TB PPDUs and UHR TB PPDUs. The UHR variant of common info field may be determined based on values of the bits B54 and B55 of common info field in the Trigger frame, as shown in Table 5. A non-EHT HE STA may consider the common info field as an HE variant common info field. A non-UHR EHT STA may interpret the common info field as an HE variant common info field if bits B54 and B55 in the common info field both have value ‘1’. Otherwise, the non-UHR EHT STA may interpret the common info field as an EHT variant common info field.

A UHR or UHR+ STA may consider bits B54 and B55 together as a trigger variant indication field. A UHR/UHR+ STA may interpret the combination of the two bits B54 and B55 differently from pre-UHR STAs. Table 5 shows examples of how different types of STAs interpret the bits B54 and B55. A UHR/UHR+ STA may interpret the common info field as an HE variant common info field if bits B54 and B55 in the common info field each have value ‘1’. A UHR/UHR+ STA may interpret the common info field as an EHT variant common info field if bit B54 in the common info field have value ‘0’ or ‘1’, and bit B55 in the common info field has value ‘1’. If bit B54 is set to ‘0’ and bit B55 is set to ‘1’, a UHR or UHR+ STA may consider the common info field as a UHR/UHR+ variant common info field. With a UHR/UHR+ variant common info field, currently reserved bits, such as any of bits B56-B63 of the common info field, may carry UHR/UHR+ related information.

In an example, bits B54 and B55 in the common info field may also be used to indicate the variant of the special user info field if present (as shown in Table 5). A pre-EHT HE STA (or non-EHT HE STA) may interpret the special user info field as a user info field not addressed to itself. A non-UHR EHT STA may interpret the special user info field as an EHT special user info field. A UHR/UHR+ STA may interpret the special user info field as an EHT variant special user info field if bit B54 of the common info field has value ‘0’ or ‘1’, and bit B55 of the common info field has value ‘1’. If bit B54 is set to ‘0’ and bit B55 is set to ‘1’, a UHR or UHR+ STA may consider the special user info field as a UHR/UHR+ variant special user info field. Since non-UHR EHT STAs interpret the special user field as an EHT variant special user info field, currently reserved bits in the special user info field (e.g., any of bits B37-B39) may be used to carry UHR/UHR+ related information (e.g., UEQM Indication subfield, D-RU Indication subfield, MAP Trigger Indication subfield, ELR Indication subfield, Reverse Trigger Indication subfield, and/or Intermediate FCS subfield).

In an example, PHY version ID subfield may be used to indicate whether the special user info field is a UHR variant special user info field as explained hereinbefore. In an example, a combination of any procedures described herein may be used to indicate whether the special user info field is a UHR variant special user info field.

TABLE 5
Example values of B54 and B55 to determine
the variant of the common info field

| | | | | | Common Info |
|---|---|---|---|---|---|
| | | | Common | Common | field |
| | | Special | Info field | Info field | variant |
| Common | Common | User | variant for | variant for | for |
| Info field | Info field | Info | pre-EHT | non-UHR | UHR/UHR+ |
| B54 | B55 | field | HE STA | EHT STA | STA |
| 1 | 1 | No | HE variant | HE variant | HE variant |
| 0 | 0 | EHT | HE variant | EHT | EHT variant |
| | | variant | | variant | |
| 1 | 0 | EHT | HE variant | EHT | EHT variant |
| | | variant | | variant | |
| 0 | 1 | UHR | HE variant | Not valid | UHR/UHR+ |
| | | variant | | | variant |

A user info field that is addressed to a non-EHT HE STA may be an HE variant. A user info field that is addressed to a non-UHR EHT STA may be an HE variant or an EHT variant. A user info field that is addressed to a UHR STA may be an HE variant or an EHT variant or a UHR variant. The user info field is an HE variant addressed to a non-UHR EHT STA if bit B39 of the user info field is set to value ‘0’ and bit B54 of the common info field is set to value ‘1’ in the trigger frame; and is an EHT variant otherwise. In an example, the user info field is an HE variant addressed to a UHR STA (e.g., UHR non-AP STA or UHR AP STA) if bit B39 of the user info field has value ‘0’ and UHR special user info field is not present in the Trigger frame; and is a UHR variant otherwise.

In an example, the user info field is an HE variant addressed to a UHR STA (e.g., UHR non-AP STA or UHR AP STA) if bit B39 of the user info field is set to ‘0’ and A-PPDU indication subfield in the common info field or special user info field is enabled. In an example, a currently reserved bit in the user info field (e.g., bit B25) may be used to indicate the user info field may be a UHR/UHR+ variant user info field. Whether it is a UHR variant or UHR+ variant user info field may depend on the variant of the special user info field presented.

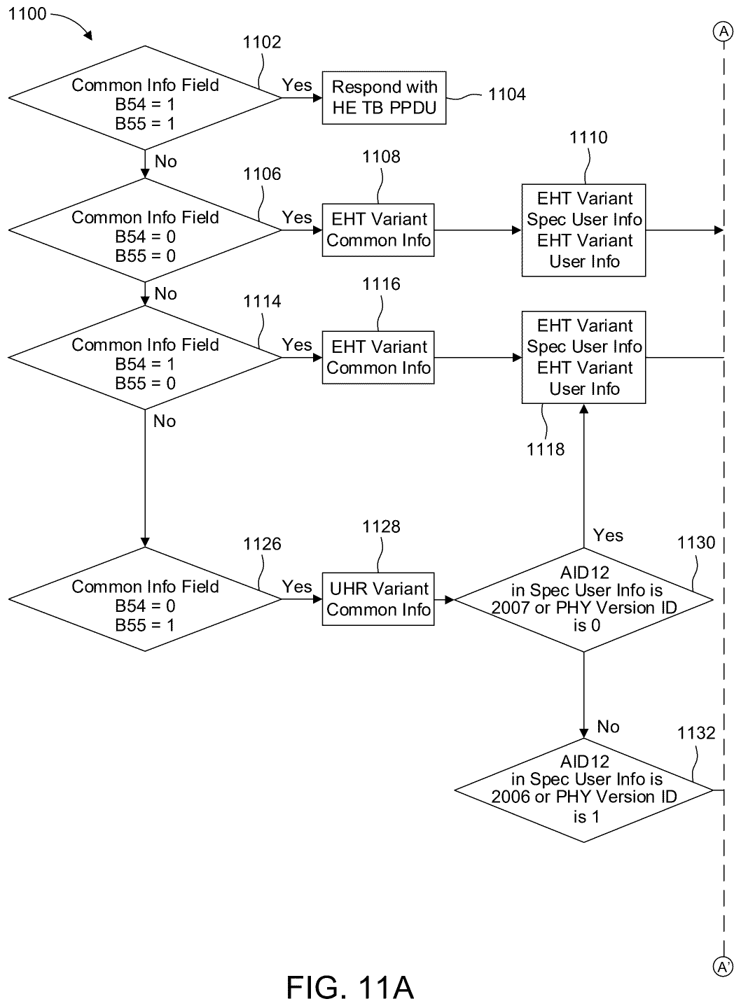

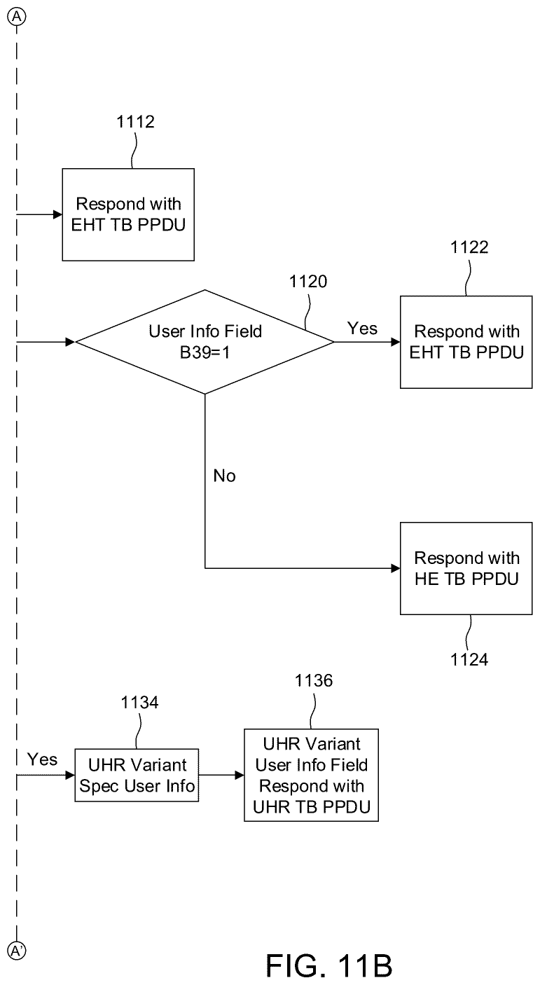

FIGS. 11A and 11B are a flow diagram illustrating another example procedure 1100 for determining a TB PPDU variant, performed by a STA that is a UHR or UHR+ STA, in response to receiving a trigger frame, from an AP, that includes a user info field addressed to the STA. The STA may check bits B54 and B55 in the common info field. At 1102, if B54=1 and B55=1, then the STA may consider the common info field as an HE variant common Info field. In this case, the special user info field may not be present. The user info field addressed to the STA is an HE variant user info field. At 904, the STA may respond to the trigger frame by transmitting, to the AP, an HE TB PPDU (i.e., based on the determined HE variant).

Otherwise, at 1106, if B54=0 and B55=0, then, at 1108, the STA may consider the common info field as an EHT variant common info field. In this case, at 1110, the special user info field is present, and it is an EHT variant special user info field. The User info field addressed to the STA is an EHT variant user info field. At 1112, the STA may respond to the trigger frame by transmitting, to the AP, an EHT TB PPDU. At 1114, if B54=1 and B55=0, then at 1116 the STA may consider the common info field as an EHT variant common info field. The special user info field is present. At 1118, the special user info field is determined to be an EHT variant special user info field. This setting may be used to enable A-PPDU transmissions as needed. The user info field addressed to the STA is an EHT variant User Info field. In an example, at 1120, if the bit B39 of the user info field is set to ‘1’, then at 1122 the STA may respond to the trigger frame by transmitting, to the AP, an EHT TB PPDU. Otherwise, if bit B39 of the user info field is set to ‘0’, then at 1124 the STA may respond to the trigger frame by transmitting, to the AP, an HE TB PPDU. In an example not shown in FIGS. 11A and 11B, if bit B39 of the user info field is set to ‘1’, the STA may respond to the trigger frame by transmitting, to the AP, an UHR TB PPDU. If bit B39 of the user info field is set to ‘0’, the STA may respond to the Trigger frame by transmitting, to the AP, an HE TB PPDU.

Otherwise, at 1126, if B54=0 and B55=1, then the STA may, at 1128, consider the common info field as an UHR variant common info field. The special user info field is present. At 1130, if the AID12 subfield in the special user info field has value ‘2007’ or the PHY version ID subfield in the special user info field is ‘0’, at 1118 the special user info field is an EHT variant special user info field. In an example, the user info field addressed to the STA is an EHT variant user info field. At 1120, if bit B39 of the user info field is set to ‘1’, the STA at 1122 may respond to the trigger frame by transmitting an EHT TB PPDU. If bit B39 of the user info field is set to ‘0’, the STA at 1124 may respond to the trigger frame by transmitting an HE TB PPDU. In an example not shown, the user info field addressed to the STA is an UHR variant user info field. If bit B39 of the user info field is set to ‘1’, the STA may respond to the trigger frame by transmitting an UHR TB PPDU. If bit B39 of the user info field is set to ‘0’, the STA may respond to the trigger frame by transmitting an HE TB PPDU. At 1132, if the AID12 subfield in the special user info field has value ‘2006’, or the PHY version ID subfield in the special user info field is ‘1’, then at 1134 the determines that the special user info field is a UHR variant special user info field. The user Info field addressed to the STA is a UHR variant user info field. The STA may at 1136 respond to the trigger frame by transmitting a UHR TB PPDU.

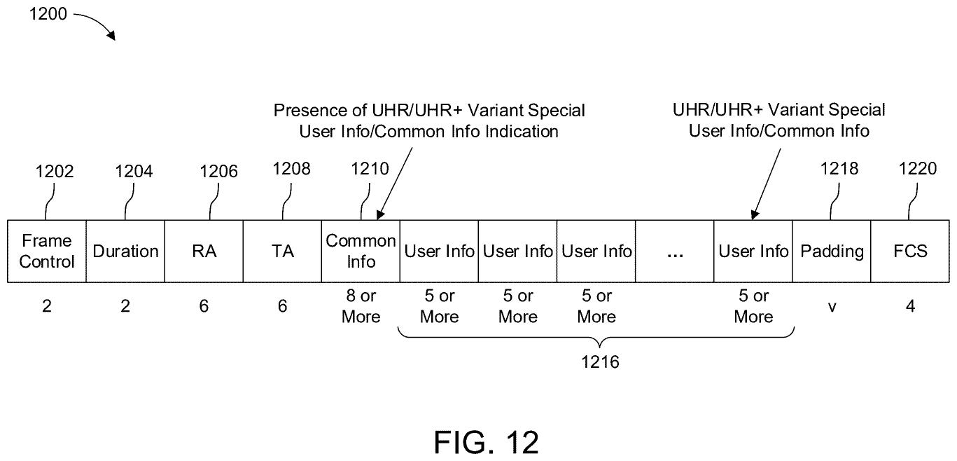

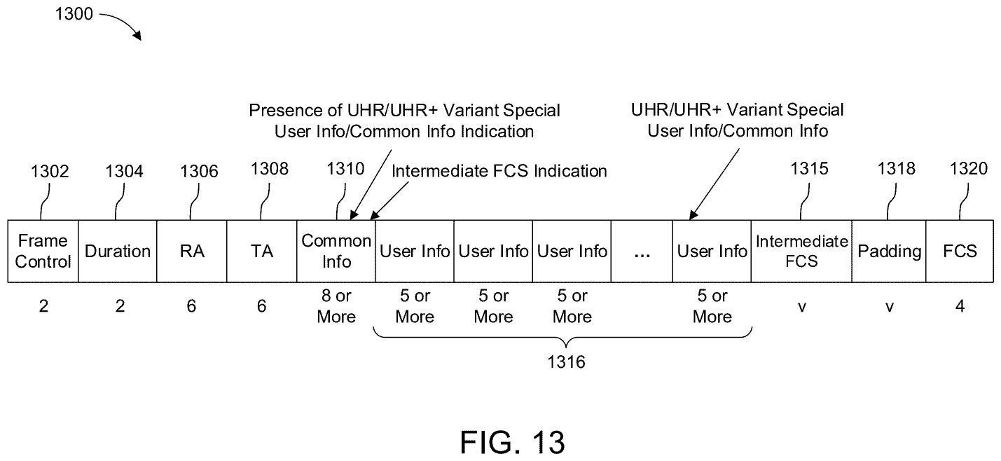

In an example embodiment, a special user info field may be included at the end of a trigger frame. UHR variant common and/or special info field may be added before padding but after other user info fields as shown in FIG. 12. FIG. 12 is a frame format diagram illustrating an example trigger frame 1200 format including a UHR/UHR+ variant common info and/or special user info field added before the padding bits at the end of the trigger frame 1200. An example trigger frame 1200 may include, but is not limited to, any of the following fields: frame control field 1202; duration field 1204; RA field 1206; TA field 1208; common info field 1210; multiple user info fields 1216; padding field 1218; and/or FCS field 1220. The common info field 1210 may include a subfield (e.g., UHR Variant Common/Special Indication subfield) that indicates the presence of the UHR/UHR+ variant special user info field and/or common info field at the end of the trigger frame 1200. When this subfield is set to true, UHR/UHR+ STAs may locate the UHR/UHR+ variant special user Info and/or common info field right before the padding bits/fields 1218. If an Intermediate FCS field is present, the UHR variant common and/or special info field may be added before the intermediate FCS field, as shown in FIG. 13. FIG. 13 is a frame format diagram illustrating an example trigger frame 1300 format including a UHR/UHR+ variant common info and/or special user info field added before the intermediate FCS field 1315 at the end of the trigger frame 1300. Example trigger frame 1300 may include, but is not limited to, any of the following fields: frame control field 1302; duration field 1304; RA field 1306; TA field 1308; common info field 1310; multiple user info fields 1316 intermediate FCS field 1315; padding field 1318; and/or FCS field 1320. In an example, an intermediate FCS indication subfield (not shown) may be included in the common info field 1310. When both intermediate FCS indication subfield and the UHR variant common/special indication subfield are set to true, UHR/UHR+ STAs may locate the UHR/UHR+ variant special user info field 1316 and/or common info field 1310 right before the intermediate FCS field 1315.

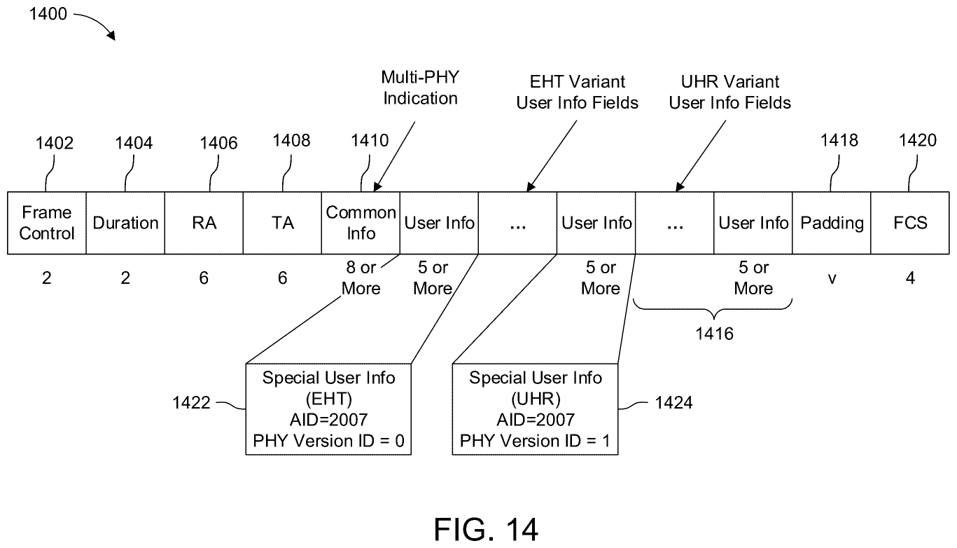

The example procedures described herein may be extended to solicit aggregated HE TB PPDUs and/or EHT TB PPDUs and/or UHR TB PPDUs by including more than one special user field. An example of trigger frame with multiple special user info fields is shown in FIG. 14. FIG. 14 is a frame format diagram illustrating an example trigger frame 1400 format including multiple special user info fields 1422 and 1424. Example trigger frame 1400 may include, but is not limited to, any of the following fields: frame control field 1402; duration field 1404; RA field 1406; TA field 1408; common info field 1410; multiple user info fields 1416; special user info fields 1422 and 1424; padding field 1418; and/or FCS field 1420. In this example, a multi-PHY indication field (or A-PPDU Indication field) may be included in the common info field 1410 to indicate the presence of more than one special user info field in the trigger frame 1400. A present EHT variant special user info field 1422 may be the first user info field 1416 following the common info field 1410. The user info fields 1416 that follow the kth special user info field but before the k+1th special user info field may be with the same variant identified by the PHY version ID subfield of the kth special user info field (e.g., k=1, 2 or more).

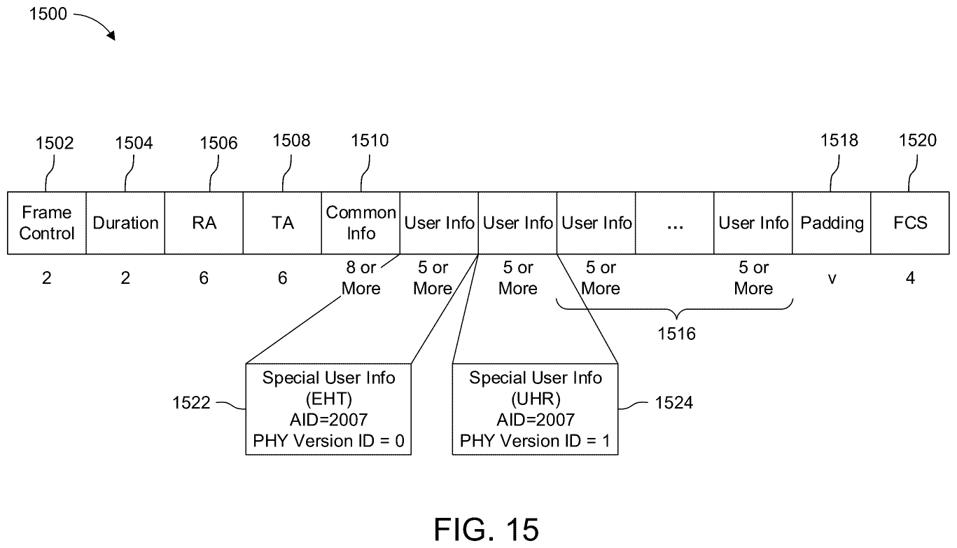

The second example of Trigger frame with multiple Special User Info fields is shown in FIG. 15. FIG. 15 is a frame format diagram illustrating an example trigger frame 1500 format including multiple special user info fields 1522 and 1524. Example trigger frame 1500 may include, but is not limited to, any of the following fields: frame control field 1502; duration field 1504; RA field 1506; TA field 1508; common info field 1510; multiple user info fields 1516; special user info fields 1522 and 1524; padding field 1518; and/or FCS field 1520. In this example, the first one or two or more user info fields 1516 may be special user info fields 1522 and 1524. The special user info fields 1522 and 1524 may be with the same variant or different variant. An EHT variant special user info field 1522 may be the first user info field 1516 following the common info field 1510. The user info fields 1516 that follow the first special user info field 1522 may be with EHT variant and/or UHR variant or a UHR+ variant.

Example signaling and rules are described hereinafter, that may be used with any of the example procedures described herein (e.g., procedure 900 of FIGS. 9A and 9B). In an example, when multiple (>=1) Special User Info fields are present, UHR/UHR+ STAs may follow the UHR/UHR+ variant Special User field and non-UHR EHT STAs may follow the EHT variant Special User field. User Info field addressed to a UHR/UHR+ STA is a UHR/UHR+ variant User Info field. User Info field addressed to a non-UHR EHT STA is an EHT variant User Info field.

In another example, a Frequency Subblock Index subfield may be carried in the UHR variant or UHR+ variant Special User Info field or Common Info field. The Frequency Subblock Index subfield may be used to indicate a unique sub-block in frequency domain within the operating bandwidth. The signaling and parameters carried in the UHR/UHR+ variant Special User Info field may be applied to the STAs for which the allocated frequency resources are within the frequency sub-block identified by the Frequency Subblock Index subfield. In an example, the STA that identifies the variant of the STA's Special User Info field may respond using the variant of TB PPDU. That is, if a STA identifies that its assigned RU is within a frequency subblock that is associated with the Special User Info field, and the Special User Info field is a UHR variant, then the STA may respond with a UHR TB PPDU. Each frequency subblock may be specified with a fixed size (e.g., 80 MHz or 160 MHz). In an example, a special value may of the Frequency Subblock Index subfield may be used to indicate the whole operation bandwidth. A UHR/UHR+ STA with a User Info field addressed to the STA may check the RU Allocation subfield and PS160 subfield of the User Info field to identify the location of its assigned RU. If the RU is within the frequency subblock identified by the Frequency Subblock Index subfield of the UHR/UHR+ variant Special User Info field, the UHR/UHR+ STA may interpret its User Info field as a UHR/UHR+ variant User Info field depending on the type of the variant of the Special User Info field (e.g., UHR or UHR+ such that UHR+ may refer to any future 802.11 generation). If the UHR/UHR+ STA may follow the setting in the UHR/UHR+ variant Special User Info field. If the STA cannot find a UHR/UHR+ variant Special User Info field matches the STA's assigned RU, the STA may follow the rule defined in 802.11be or 802.11ax to identify the variant of the User Info field. With this method, the RU Allocation subfield and PS160 subfield may need to be designed in such a way that all STAs which understand Trigger frame can determine the same frequency sub-block the assigned RU is located. For example, B39 of the Special User Info field is always used as PS160 subfield. B12 of the Special User Info field is part of the RU Allocation subfield is used as an indication of the upper or lower, or primary or secondary, 80 MHz subchannel within a 160 MHz subchannel, and together with PS160 subfield to indicate an 80 MHz sub-block. Example values of the Frequency Subblock Index subfield in the Special User Info field is given in Table 6. Any example procedure for determining a TB PPDU variant described herein may be used in combination with a Trigger frame with two or more Special User Info fields (e.g., procedure 900 in FIGS. 9A and 9B, procedure 1000 in FIGS. 10A and 10B, or procedure 1100 in FIGS. 11A and 11B).

TABLE 6
Example Values of the Frequency Subblock Index subfield
in the UHR/UHR+ variant Special User Info field

| Value | Meaning |
|---|---|
| 0 | The first 80 MHz frequency sub-block (the mapping from |
| | the first sub-block to the physical frequency sub-block |
| | may be defined. For example, the first sub-block may |
| | be the primary 80 MHz sub-block, or the 80 MHz sub-block |
| | with highest frequency etc.) |
| 1 | The second 80 MHz frequency sub-block |
| 2 | The third 80 MHz frequency sub-block |
| 3 | The fourth 80 MHz frequency sub-block |
| 4 | The first 160 MHz frequency sub-block |
| 5 | The second 160 MHz frequency sub-block |
| 6 | Whole operation channel width |

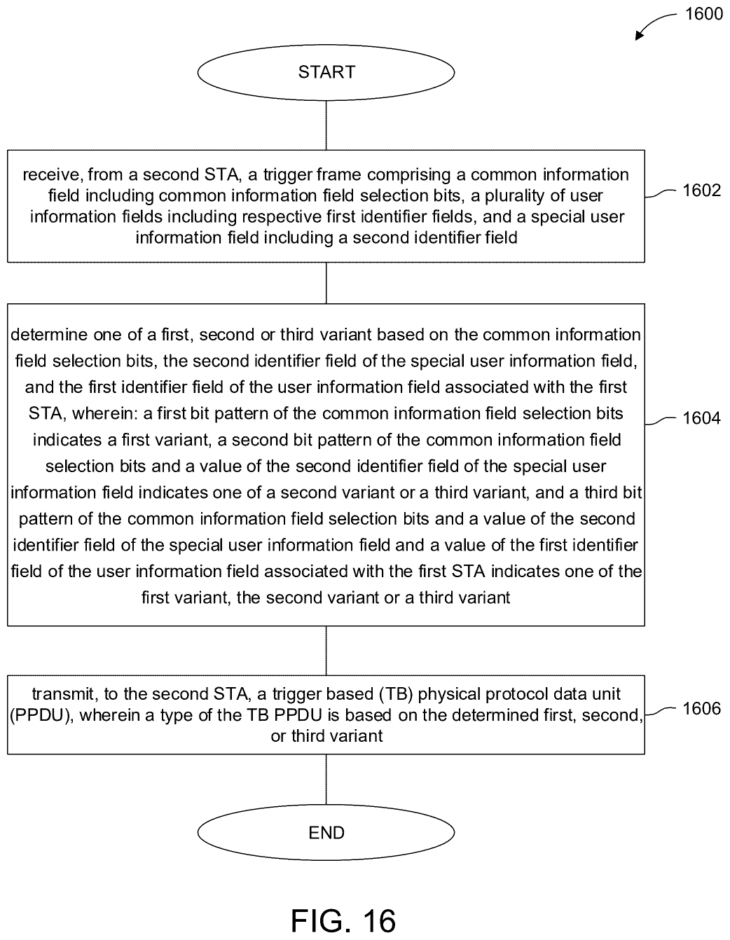

FIG. 16 is a flow diagram illustrating an example procedure 1600 for determining a TB PPDU variant, performed by a first STA that is a UHR or UHR+ STA, in response to receiving a trigger frame, from a second STA (e.g., an AP), that includes a user info field addressed to the first STA. At 1602, the first STA may receive, from a second STA, a trigger frame comprising a common information field including common information field selection bits, a plurality of user information fields including respective first identifier fields, and a special user information field including a second identifier field. At 1604, the first STA may determine one of a first, second or third variant based on the common information field selection bits, the second identifier field of the special user information field, and the first identifier field of the user information field associated with the first STA, wherein: a first bit pattern of the common information field selection bits indicates a first variant, a second bit pattern of the common information field selection bits and a value of the second identifier field of the special user information field indicates one of a second variant or a third variant, and a third bit pattern of the common information field selection bits and a value of the second identifier field of the special user information field and a value of the first identifier field of the user information field associated with the first STA indicates one of the first variant, the second variant or a third variant. At 1606, the first STA may transmit, to the second STA, a TB PPDU, wherein a type of the TB PPDU is based on the determined first, second, or third variant.

The UHR/UHR+ related information may be carried in the HE/EHT variant Common Info field, UHR/UHR+ variant Common Info field, EHT/UHR/UHR+ variant Special User Info field, and/or HE/EHT/UHR/UHR+ variant User Info field.

The UHR/UHR+ related information may include but is not limited to any of the following information: UEQM Indication subfield may indicate UEQM is enabled in the TB PPDU; D-RU Indication subfield may indicate dRU is enabled in the TB PPDU; MAP Trigger Indication subfield may indicate the trigger frame may solicit trigger based PPDUs from one or more APs; ELR Indication subfield may indicate the solicited TB PPDU may be an ELR TB PPDU; Reverse Trigger Indication subfield may indicate the trigger frame may be transmitted by a non-AP STA to solicit a response frame from an AP, such that the response frame from the AP may be a TB PPDU or non-HT Dup PPDU or UHR MU PPDU; Intermediate FCS subfield may indicate the additional/intermediate FCS for UHR/UHR+ STAs that precedes padding, and the FCS field is present in the Trigger frame; and/or A-PPDU Indication subfield may indicate the solicited TB PPDU may be an A-PPDU.

With trigger based (TB) UEQM transmissions, an AP may transmit a Trigger frame that includes resource allocations and MCS assignments for the following TB PPDU. One or more intended receiving STAs may respond using a TB PPDU based on the resource allocation and MCS assignment. Once UEQM is indicated in the Trigger frame, the corresponding UEQM signaling may be carried in one or more User Info fields.

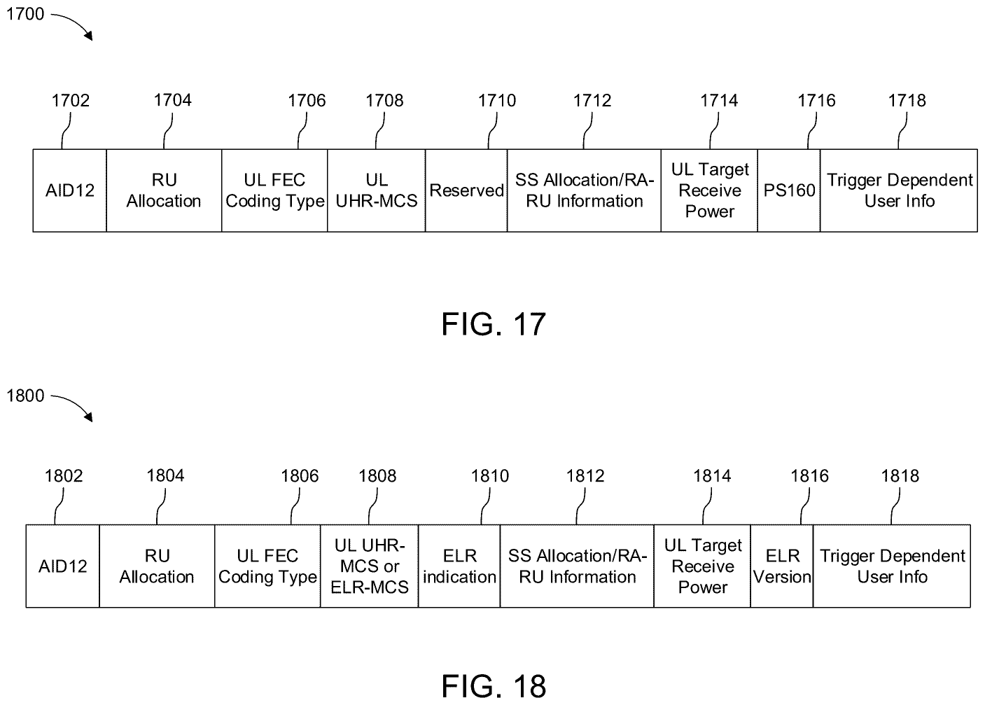

In an example, a STA with UEQM may have two or more UHR/UHR+ variant User Info fields. The User Info field may reuse the EHT variant User Info field format as shown in FIG. 17 with slight modification to replace UL EHT-MCS subfield with UL UHR-MCS subfield. All the User Info fields associated with the same STA may have the same AID12 subfield, RU Allocation subfield, UL FEC Coding Type subfield, UL Target Receive Power subfield, PS160 subfield, but different UL EHT MCS and SS Allocation subfields. In an example, the number of User Info fields associated with a single STA may be the same as the number of spatial streams assigned to the STA. The first User Info field associated with the STA may indicate the modulation order and SS index for the first spatial stream and the second User Info field associated with the STA may indicate the modulation order and SS index for the second spatial stream and so on. The SS Allocation subfield may be used to indicate the SS index for a spatial stream of a STA. FIG. 17 is a frame format diagram illustrating an example user info field 1700 format for UEQM. User info field 1700 for UEQM may include, but is not limited to, any of the following fields: AID12 field 1702; RU allocation field 1704; UL FEC coding type field 1706; UL UHR-MCS field 1708; reserved field 1710; SS allocation/RA-RU information field 1712; UL target receive power field 1714; PS160 field 1716; and/or a trigger dependent user info field 1718.

In an example, several rules may be applied to limit the use of the UEQM. For example, UEQM may be used for certain RUs/MRUs/dRUs with size larger than or equal to a threshold (e.g., 242-tone). The RU/MRU/dRU assigned for UEQM may be allocated to a single user. The modulation order combinations/patterns for UEQM assignment may be limited etc. With this rule, the UEQM may be signaled using one User Info field. For example, the UL UHR-MCS may indicate the base modulation for the UEQM. The base modulation may be used by the first spatial stream. The SS Allocation subfield may be used to indicate the UEQM modulation pattern for the multiple spatial streams. The SS Allocation subfield may be a table where each entry may indicate the number of spatial streams K and the modulation order difference from the kth spatial stream to the base spatial stream, k=2, . . . , K. For example, entry 0 may indicate two spatial streams and M2=M1-1. Here M1 is the base modulation order index (i.e., a constellation index) and M2 is the modulation order index for the second spatial stream.

The dRU indication may be included in the Common Info field or Special User Info field and applied to all the intended users for the upcoming TB PPDU transmissions. With trigger-based (TB) dRU transmissions, an AP may transmit a Trigger frame which include resource allocations for the following TB PPDU. One or more intended receiving STAs may respond using a TB PPDU based on the resource allocation. Once DRU is indicated in the Trigger frame, the corresponding DRU signaling may be carried in one or more User Info fields. For example, the RU Allocation field may follow a table which includes dRU allocations.

An AP may transmit a Trigger frame that includes ELR indication, ELR version, resource allocations, MCS assignments, LDPC/BCC selection, and Carrier Frequency Offset (CFO) correction for the following TB PPDU. Depending on the ELR indication, one or more intended receiving STAs may respond using ELR transmission with the assigned transmission parameters in the TB PPDU, while one or more other intended receiving STAs may respond using non-ELR transmission with the assigned transmission parameters in the TB PPDU. With different RUs indicated in RU Allocation for different STAs, OFDMA with TB ELR PPDU may be enabled among the STAs responding with ELR and/or non-ELR transmissions. In an example, a new Trigger Type (in the Common Info field) value may be added to the definitions in Table 1 (e.g., ‘9’) for ELR. In an example, the ELR Indication subfield may be added to Common Info field or Special Info field.

An example of the User Info field bit allocation is as shown in FIG. 18. There is one bit for ELR indication and one or more bits for ELR Version. The MCS field is set to a UL UHR-MCS if ELR Indication is 0 or an ELR-MCS if ELR Indication is 1. UHR-MCS refers to those MCSs defined for non-ELR UHR PPDUs, and ELR-MCS refers to those MCSs defined for ELR UHR PPDUs. An ELR-MCS definition may include the duplication method used in time/frequency/spatial domains, the coding method and rate, the modulation order or the constellation index used on data subcarriers, and other modulation and coding information. The AP may calculate the CFO Correction number for a STA and indicate if and how much CFO correction the STA needs to perform before its UL TB transmission. The parameters related to CFO correction may be given in the Trigger Dependent User Info subfield, or in place of SS Allocation/RA-RU Information subfield. FIG. 18 is a frame format diagram illustrating an example user info field 1700 format for ELR. User info field 1700 for ELR may include, but is not limited to, any of the following fields: AID12 field 1802; RU allocation field 1804; UL FEC coding type field 1806; UL UHR-MCS or ELR-MCS field 1808; ELR indication field 1810; SS allocation/RA-RU information field 1812; UL target receive power field 1814; ELR Version field 1816; and/or a trigger dependent user info field 1818.

In another example, ELR-related parameters such as ELR-MCS, ELR Indication, ELR Version, and CFO correction are all given in the Trigger Dependent User Info subfield.

In the example embodiments described herein, UHR is used as an example to demonstrate how to extend a Trigger frame to allow new generation of amendment in the 802.11 system. The disclosed methods and signaling may be applied to UHR or UHR+ related PPDU, SIG field and Trigger frames. Here UHR+ may refer to any 802.11 amendment later than 802.11bn. In another word, UHR disclosed in here may be replace may other terminologies appeared in a later version of 802.11 standards.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A first station (STA) comprising:
a transceiver; and
a processor,
wherein the transceiver and processor are configured to:
receive, from a second STA, a trigger frame comprising a common information field including common information field selection bits, a plurality of user information fields including respective first identifier fields associated respectively with a plurality of STAs including the first STA, and a special user information field including a second identifier field;
determine one of a first, second or third variant based on the common information field selection bits, the second identifier field of the special user information field, and the first identifier field of the user information field associated with the first STA, wherein:
a first bit pattern of the common information field selection bits indicates the first variant,
a second bit pattern of the common information field selection bits and a value of the second identifier field of the special user information field indicates one of the second variant or the third variant, and
a third bit pattern of the common information field selection bits and a value of the second identifier field of the special user information field and a value of the first identifier field of the user information field associated with the first STA indicates one of the first variant or the second variant; and
transmit, to the second STA, a trigger based (TB) physical protocol data unit (PPDU), wherein a type of the TB PPDU is based on the determined first, second, or third variant.

2. The first STA of claim 1, wherein the common information field selection bits include a high efficiency (HE)/extremely high throughput (EHT) P160 bit and a special user information field present bit.

3. The first STA of claim 1, wherein the common information field selection bits comprise two bits identified as B54 and B55 in the common information field.

4. The first STA of claim 1, wherein the first identifier field of the user information field associated with the first STA is at least one of a reserved field, a bit B39, or a PS160 field.

5. The first STA of claim 1, wherein the second identifier field in the special user information field is a physical (PHY) version identifier (ID) field.

6. The first STA of claim 1, wherein the first variant is high efficiency (HT) associated with 802.11ax, the second variant is extremely high throughput (EHT) associated with 802.11be, and the third variant is ultra high reliability (UHR) associated with 802.11bn.

7. The first STA of claim 6, wherein the EHT variant is backwards compatible with the HT variant, and the UHR variant is backwards compatible with the HT variant and the EHT variant.

8. The first STA of claim 6, wherein the EHT variant enables a maximum throughput of at least 30 Gbps.

9. The first STA of claim 6, wherein the UHR variant enables a maximum throughput of at least 100 Gbps.

10. The first STA of claim 1 configured as an ultra high reliability (UHR) enabled STA.

11. A method performed by a first station (STA), the method comprising:
receiving, from a second STA, a trigger frame comprising a common information field including common information field selection bits, a plurality of user information fields including respective first identifier fields associated respectively with a plurality of STAs including the first STA, and a special user information field including a second identifier field;
determining one of a first, second or third variant based on the common information field selection bits, the second identifier field of the special user information field, and the first identifier field of the user information field associated with the first STA, wherein:
a first bit pattern of the common information field selection bits indicates the first variant,
a second bit pattern of the common information field selection bits and a value of the second identifier field of the special user information field indicates one of the second variant or the third variant, and
a third bit pattern of the common information field selection bits and a value of the second identifier field of the special user information field and a value of the first identifier field of the user information field associated with the first STA indicates one of the first variant or the second variant; and
transmitting, to the second STA, a trigger based (TB) physical protocol data unit (PPDU), wherein a type of the TB PPDU is based on the determined first, second, or third variant.

12. The method of claim 11, wherein the common information field selection bits include a high efficiency (HE)/extremely high throughput (EHT) P160 bit and a special user information field present bit.

13. The method of claim 11, wherein the common information field selection bits comprise two bits identified as B54 and B55 in the common information field.

14. The method of claim 11, wherein the first identifier field of the user information field associated with the first STA is at least one of a reserved field, a bit B39, or a PS160 field.

15. The method of claim 11, wherein the second identifier field in the special user information field is a physical (PHY) version identifier (ID) field.

16. The method of claim 11, wherein the first variant is high efficiency (HT) associated with 802.11ax, the second variant is extremely high throughput (EHT) associated with 802.11be, and the third variant is ultra high reliability (UHR) associated with 802.11bn.

17. The method of claim 16, wherein the EHT variant is backwards compatible with the HT variant, and the UHR variant is backwards compatible with the HT variant and the EHT variant.

18. The method of claim 16, wherein the EHT variant enables a maximum throughput of at least 30 Gbps.

19. The method of claim 16, wherein the UHR variant enables a maximum throughput of at least 100 Gbps.

20. The method of claim 11, wherein the first STA is configured as an ultra high reliability (UHR) enabled STA.
